(19) United States
(12) Patent Application Publication
(10) Pub. No.: US 2006/0192778 A1
(43) Pub. Date: Aug. 31, 2006

(54) Apparatus and method for outputting print data

(75) Inventor: Tsutomu Otani, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/359,164

(22) Filed: Feb. 21, 2006

(30) Foreign Application Priority Data
Feb. 21, 2005 (JP) 2005-043536

(51) Int. Cl. G06T 15/00

(52) U.S. Cl. 345/419

(57) ABSTRACT

In order to output print data representative of an image to be printed by a printer, first image data representative of a first image of an object is generated based on first polygon data representative of a three-dimensional shape of the object with coordinates of apexes of each of first polygons constituting a surface of the object and having a first size. The first image is displayed. When a print instruction for the first image is detected, at least one of the first image data and the first polygon data is acquired to generate second image data representative of a second image of the object which includes second polygon data representative of the three-dimensional shape of the object with coordinates of apexes of each of second polygons constituting the surface of the object and having a second size smaller than the first size. Plural sets of the print data each of which includes a prescribed amount of the second image data are generated. Each of the sets of the print data is sequentially outputted.

### BACKGROUND OF THE INVENTION

The present invention relates to a technology of forming to print a two-dimensional image from a three-dimensional data formed by using a computer graphics technology.

In recent years, a virtual world created by imagination can be expressed as if the world were existed by progress of a so-to-speak computer graphics (CG) technology. Further, there has also been developed a game machine in which in a virtual world expressed as if it were existed by utilizing such a technology, a game is advanced by moving a character which is also expressed as if it were existed and the game machine is widely used currently.

In a case of dealing with a three-dimensional body on CG, it is general to use a method of dividing a surface of the body into small plane polygonal shapes and expressing the body by an aggregation of the polygonal shapes. The polygonal shape used for specifying a shape of the body in this way is referred to as “polygon”. Since the polygon is a plane, the surface of the body expressed by using the polygon gives an angular feeling and there is a concern of giving a strange feeling, however, such a problem can be improved to a nonproblematic degree in fact by reducing a size of the polygon. Naturally, when the size of the polygon is reduced, a number of the polygons serving as the body is increased and therefore, it is difficult to swiftly display an image. Hence, a size of polygon is determined by a balance between a request for expressing the body as if it were an existing object and a speed of expressing the image.

According to the game machine utilizing the CG technology, a request for the speed of expressing the image is further enhanced. That is, in a case where the game machine, a character needs to be moved fast in response to an operation of a game player and for such a purpose, the image needs to be displayed swiftly. On the other hand, the character is frequently moved during the game to bring about a characteristic that the angular feeling of the surface is difficult to be conspicuous. Hence, the size of the polygon is set by placing a weight on the speed of displaying the image rather than expressing the body as if it were real. Further, various technologies have been developed and proposed to be able to display an image swiftly while expressing a body expressed by a polygon as if it were a more real object (for example, disclosed in Japanese Patent Publication Nos. 7-262387A and 8-161510A).

However, even if an object is displayed like an existing object on a screen, it could be seen that the surface of the object is angular when the object is printed on a medium on which an image can be expressed clearer such as paper. When it was seen from the printed image that the surface of the object is angular, it might be recognized that the object which has been displayed on the screen is expressed virtually.

### SUMMARY OF THE INVENTION

It is therefore an object of the present invention to provide a technology allowing an object displayed on a screen to be expressed like an existing object when the object is printed on a medium on which an image can be expressed clearer such as paper.

In order to achieve the above object, according to the invention, there is provided an apparatus for outputting print data representative of an image to be printed by a printer, comprising:

a first data generator, operable to generate first image data representative of a first image of an object, based on first polygon data representative of a three dimensional shape of the object with coordinates of apexes of each of first polygons constituting a surface of the object and having a first size;

a display, operable to display the first image;

a second data generator, operable to acquire, when a print instruction for the first image is detected, at least one of the first image data and the first polygon data to generate second image data representative of a second image of the object which includes second polygon data representative of the three-dimensional shape of the object with coordinates of apexes of each of second polygons constituting the surface of the object and having a second size smaller than the first size;

a third data generator, operable to generate plural sets of the print data each of which includes a prescribed amount of the second image data; and

data transmitter, operable to output each of the sets of the print data sequentially.

According to the invention, there is also provided a method of outputting print data representative of an image to be printed by a printer, comprising:

generating first image data representative of a first image of an object, based on first polygon data representative of a three-dimensional shape of the object with coordinates of apexes of each of first polygons constituting a surface of the object and having a first size;

displaying the first image;

acquiring, when a print instruction for the first image is detected, at least one of the first image data and the first polygon data, to generate second image data representative of a second image of the object which includes second polygon data representative of the three-dimensional shape of the object with coordinates of apexes of each of second polygons constituting the surface of the object and having a second size smaller than the first size;

generating plural sets of the print data each of which includes a prescribed amount of the second image data; and

outputting each of the sets of the print data sequentially.

With the above configuration, since the acquired print data includes the image data formed out of the small polygons, the surface of the object is not angular when the print data are printed on a medium such as paper on which an image can be expressed clear. Accordingly, it is possible to obtain an image with high quality like a photograph obtained by taking a photograph of an existing object. Further, the printed image can give an impression as if the two-dimensional image is printed as it is, since the two-dimensional image displayed on the screen has the same arrangement as the object. Accordingly, since the printed image with high quality gives an expression like an image displayed on the screen, the object displayed on the screen can be allowed to look like an existing object.

In addition, since each of the sets of the print data includes a prescribed amount of the second image data, it is possible to print an image with high quality without restriction to a memory capacity for developing the image data.

The apparatus may further comprises a storage storing the first polygon data and the second polygon data. Here, the second data generator generates the second image data by replacing at least a part of the first polygon data with the second polygon data.

With this configuration, it is possible to print an image with high quality like a photograph obtained by taking a photograph of an existing object, by storing the polygon data accurately expressing the shape of an object.

Alternatively, the second data generator may generate the second image data such that one of the first polygons is divided into a plurality of the second polygons.

With this configuration, since it is not necessary to store in advance the polygon data, it is possible save the memory capacity.

In a case where the second image data are generated from the first polygon data, the second image data are generated at the same position as the first polygon data. As a result, since it is not necessary to adjust the position the second polygon data, it is possible to simplify a processing of printing the first image.

In a case where the second image data are generated by acquiring the first image data, it is not necessary to adjust the position the second image data. Accordingly, it is possible to simplify a processing of printing the first image.

In a case where the data transmitter may sequentially output a first set of the print data representative of a first part of the second image and a second set of the print data representative of a second part of the second image which is adjacent to the first part of the second image, the data transmitter may be operable to output the second set of the print data so as to partly include data in the first set of print data.

With this configuration, it is possible to prevent the joint portions of the first and second parts of the second image from being visible, by printing the repeated portions two times.

According to the invention, there is also provided a program product comprising a program adapted to cause a computer to execute a method for outputting print data representative of an image to be printed by a printer, comprising:

generating first image data representative of a first image of an object, based on first polygon data representative of a three-dimensional shape of the object with coordinates of apexes of each of first polygons constituting a surface of the object and having a first size;

displaying the first image;

acquiring, when a print instruction for the first image is detected, at least one of the first image data and the first polygon data to generate second image data representative of a second image of the object which includes second polygon data representative of the three-dimensional shape of the object with coordinates of apexes of each of second polygons constituting the surface of the object and having a second size smaller than the first size;

generating plural sets of the print data each of which includes a prescribed amount of the second image data; and

outputting each of the sets of the print data sequentially.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing an image data generator and a color printer according to a first embodiment of the invention;

FIG. 2 is a schematic view showing a configuration of the color printer;

FIG. 3 is a schematic view showing an arrangement of nozzles in an ink ejecting head in the color printer;

FIG. 4 is a schematic view showing a state that a screen in a game is displayed on a monitor;

FIG. 5 is a schematic view showing an area that a two-dimensional image is directly displayed in the game screen of FIG. 4;

FIGS. 6A and 6B are perspective views showing a shape of a flying boat serving as a main character in the game;

FIG. 7 is a schematic view showing a state that the shape of the flying boat is expressed by minute planar polygons;

FIG. 8 is a schematic view showing an object table for managing polygon data of respective objects in the game;

FIG. 9 is a schematic view showing data structure of the polygon data;

FIG. 10 is a flowchart of processing for displaying the game screen on the monitor;

FIG. 11 is a diagram showing a principle of rendering in FIG. 10;

FIGS. 12A and 12B show equations for projecting apex coordinates of polygons constituting the object onto coordinates on a two-dimensional plane;

FIG. 13 is a diagram showing a projected image generated by the rendering;

FIG. 14 is a table showing data structure of drawing command output to draw an image generated by the rendering;

FIG. 15 is a flowchart of processing for printing image;

FIG. 16 is a schematic view showing a state that a screen for determining image capturing conditions is displayed on the monitor;

FIG. 17 is a schematic view showing a state that a screen for determining print conditions is displayed on the monitor;

FIG. 18 is a schematic view showing a state that the shape of the flying boat is expressed by the minute polygons;

FIG. 19 is a table referred to determine whether the polygon data exists or not;

FIG. 20 is a flowchart of processing for outputting print data;

FIGS. 21A and 21B are diagrams showing how to read out a prescribed number of minute polygon data;

FIGS. 22A and 22B are diagrams showing how to output image data in a frame buffer as a unit of raster;

FIGS. 23 and 24 are diagrams showing a state that new polygon data is read out from a main memory;

FIG. 25 is a flowchart of processing for printing an image;

FIG. 26 is a diagram showing a lookup table referred to execute color conversion shown in FIG. 25;

FIG. 27 is a diagram showing a part of a dither matrix used in the dithering method to execute halftoning shown in FIG. 25;

FIG. 28 is a diagram showing determination as to whether a dot is formed or not with reference to the dither matrix;

FIG. 29 is a flowchart of processing for outputting print data which is executed by a first modified example of the image data generator;

FIG. 30 is a diagram for explaining a print data outputting processing which is executed by a second modified example of the image data generator;

FIG. 31 is a flowchart of processing for printing an image which is performed in an image data generator and a printer according to a second embodiment of the invention;

FIG. 32 is a diagram showing an example in which minute polygons are generated from normal polygons; and

FIG. 33 is a diagram showing another example in which the minute polygons are generated from the normal polygons.

### DETAILED DESCRIPTION OF THE EMBODIMENTS

Embodiments of the invention will be described below in detail with reference to the accompanying drawings.

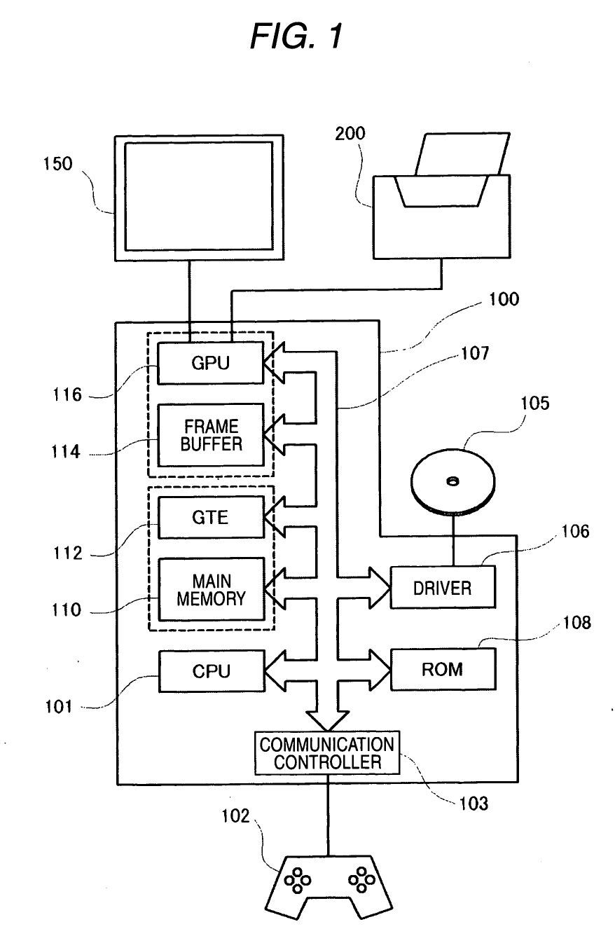

As shown in FIG. 1, a game machine 100 according to a first embodiment is constituted by connecting a main memory 110, a coordinates transformer (hereinafter, the GTE: Geometry Transfer Engine) 112, a frame buffer 114, an image processor (hereinafter, the GPU: Graphic Processing Unit) 116, a the ROM 108, a driver 106, a communication controller 103 and the like to be able to exchange data from each other by way of a bus centering on the CPU 101. Further, the game machine 100 is connected with a controller 102 or the like for operating the game machine 100. Further, the game machine 100 is also connected with a color printer 200 to be able to output a screen in the midst of a game by the color printer 200.

The CPU 101 is a central processing unit for executing so-to-speak arithmetic operation or logical operation, which governs to control a total of the game machine 100. The ROM 108 is a memory exclusive for reading and stored with various programs including a program (boot program) initially executed by the CPU 101 after activating the game machine 100. The main memory 110 is a memory capable of reading and writing data and is used as a temporarily storing region when the CPU 101 executes arithmetic operation or logical operation. The GTE 112 executes operation for moving and rotating a geometrical shape in a three-dimensional space at high speed while making access to the main memory 110 under control of the CPU 101. The GPU 116 executes a processing for forming a screen displayed on a monitor 150 at a high speed by receiving an instruction from the CPU 101. The frame buffer 114 is an exclusive memory used for forming the screen displayed on the monitor 150 by the GPU 116. The GPU 116 displays a screen in the midst of a game by reading data on the screen formed on the frame buffer 114 to output to the monitor 150. Further, when the screen in the midst of a game is printed, the screen in the midst of the game is printed by supplying data formed on the frame buffer 114 to the color printer 200 by way of the GPU 116.

Programs and various data for executing a game are stored in a storage disk of so-to-speak compact disk or digital video disk. When the storage disk 105 is set to the game machine 100, programs and data stored to the storage disk 105 are read by the driver 106 and temporarily stored in the main memory 110. Further, when a content of operating the controller 102 is inputted to the CPU 101 by way of the communication controller 103, the CPU 101 reads programs stored in the main memory 110 and executes predetermined processings, thereby, a game is executed.

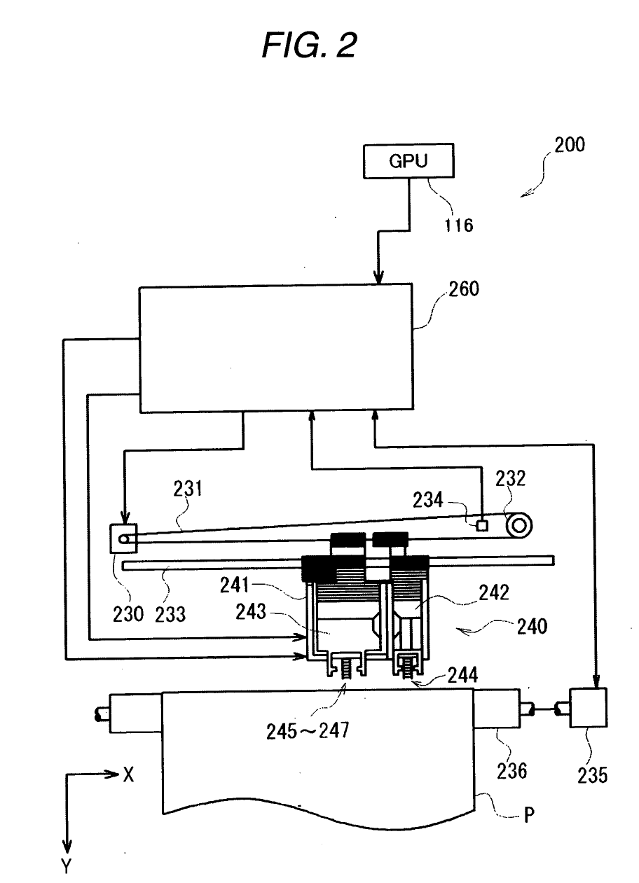

As shown in FIG. 2, the color printer 200 is an ink jet printer capable of forming dots of 4 color inks of cyan, magenta, yellow, black. Naturally, an ink jet printer capable of forming ink dots of a total of 6 colors including a cyan ink having a low concentration of a die or a pigment (light cyan) and a magenta ink having a low concentration of a die or a pigment (light magenta) in addition to the inks of 4 colors can also be used. Further, in the following, depending on cases, cyan ink magenta ink, yellow ink, black ink, light cyan ink, light magenta ink may be abbreviated as C ink, M ink, Y ink, K ink, LC ink LM ink, respectively.

As illustrated, the color printer 200 is constituted by a mechanism of ejecting inks and forming dots by driving a printing head 241 mounted on a carriage 240, a mechanism of reciprocating the carriage 240 in an axial direction of a platen 236 by a carriage motor 230, a mechanism for carrying print sheet P by a sheet feeding motor 235, and a control circuit 260 for controlling to form dots, move the carriage 240 and carry the print sheet.

The carriage 240 is mounted with an ink cartridge 242 for containing K ink and an ink cartridge 243 containing various inks of C ink, M ink, Y ink. When the ink cartridges 242, 243 are mounted to the carriage 240, respective inks in the cartridges are supplied to ink ejecting heads 244 through 247 of respective colors provided at a lower face of the printing head 241 through introducing tubes, not illustrated.

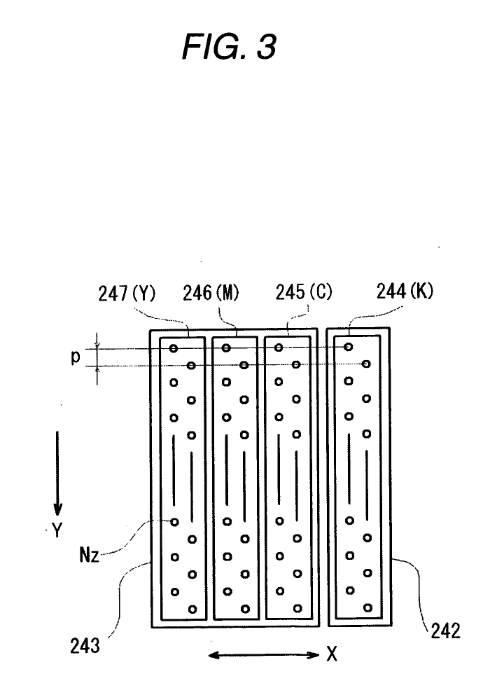

As shown in FIG. 3, bottom faces of the ink ejecting heads are formed with 4 sets of nozzle arrays for ejecting inks of respective colors of C, M, Y, K and the nozzles Nz of 48 pieces per set of a nozzle array are aligned at a constant pitch k.

The control circuit 260 is constituted by connecting the CPU, the ROM, RAM, PIF (peripheral apparatus interface) and the like to each other by a bus. The control circuit 260 controls primary scanning operation and secondary scanning operation of the carriage 240 by controlling operation of the carriage motor 230 and the sheet feeding motor 235 and controls to eject ink drops from the respective nozzles at pertinent timings based on print data supplied from outside. In this way, the color printer 200 can print a color image by forming respective colors of ink dots at pertinent positions on the print medium under control of the control circuit 260.

Further, when drive signal waveforms supplied to the nozzles are controlled for ejecting ink drops, ink dots having different sizes can also be formed by changing the sizes of ink drops to be ejected. When the sizes of the ink dots can be controlled in this way, by properly using ink dots having different sizes in accordance with a region of an image to be printed, an image having a higher image quality can also be printed.

Further, various methods are applicable to a method of ejecting ink drops from ink ejecting heads of respective colors. That is, a type of ejecting ink by using a piezoelectric element, a method of ejecting ink drops by producing bubbles in an ink path by a heater arranged at the ink path and the like can be used. Further, there can also be used a printer of a type of forming ink dots on print sheet by utilizing a phenomenon of thermal transcription or the like, or a type of adhering respective colors of toner powders on a print medium by utilizing static electricity instead of ejecting inks.

According to the color printer 200 having the above-described hardware constitution, by driving the carriage motor 230, respective colors of the ink ejecting heads 244 through 247 are moved in a primary scanning direction relative to the print sheet P and by driving the sheet feeding motor 235, the print sheet P is moved in a secondary scanning direction. By ejecting ink drops by driving the nozzles at pertinent timings in synchronism with movements of primary scanning and secondary scanning of the carriage 240 by the control circuit 260, the color printer 200 can print a color image on the print sheet.

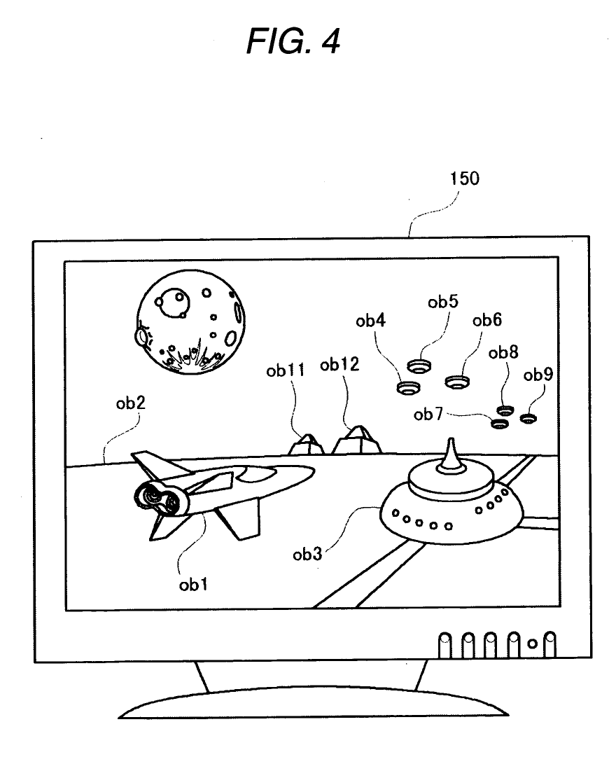

In this embodiment, a game is proceeded by operating a main character in a virtual three-dimensional space set as the stage of the game. As shown in FIG. 4, an imaginary planet surface is displayed on the illustrated screen and a behavior of setting various buildings is virtually displayed at the surface of the planet. The game is executed by maneuvering and advancing a flying boat serving as a main character in the stage of the game.

Although only a two-dimensional shape can be expressed on the screen of the monitor 150, at inside of the game machine 100, the planet surface, the flying boat, the various kinds of buildings and the like are expressed as bodies having three-dimensional shapes. An object dealt with as having a three-dimensional shape at inside of the game machine 100 in this way is referred to as “object” in the specification. In the screen exemplified in FIG. 4, a flying boat ob1 displayed to be large substantially at a center of the screen, a planet surface ob2, a dome-shaped building ob3, two pyramid-shaped buildings ob11, ob12 seen remotely, further, six of flying, circular disks ob4 through ob9 flying above the planet surface and the like are objects and data of three-dimensionally expressing surface shapes of bodies are stored therefor.

Therefore, when by operating the flying boat ob1 serving as the main character, relative to the flying boat ob1, positional relationships of other objects (for example, buildings, flying circular disks and the like) are changed, in accordance therewith, ways of viewing the objects on the monitor 150 are also changed. As a result, although the objects of the flying boat ob1, the planet surface ob2 and the like are created by imagination, the objects can be displayed on the monitor 150 as if the objects were really present. Further, according to the game machine 100 of the embodiment, by printing the screen displayed on the monitor 150, the image as if the image were taken by a photograph can be printed although a description will be given later in details.

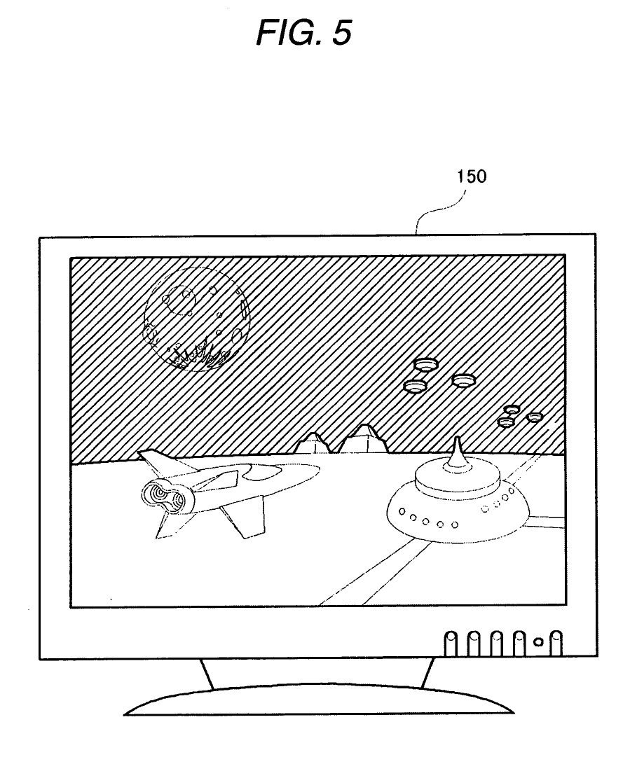

Further, according to the example shown in FIG. 4, a portion of the sky of the planet and the satellites floating in the sky do not constitute objects but two-dimensional images displayed on the monitor 150 as they are. Therefore, with regard thereto, even when the flying boat ob1 is operated, ways of viewing these on the monitor 150 are not changed. This is because these are extremely remote in comparison with a range of moving the flying boat ob1 and therefore, even when a position of the flying boat ob1 is changed, ways of viewing these hardly change and therefore, it is sufficient when these are dealt with as two-dimensional images. In FIG. 5, a hatched region displays two-dimensional images on the screen of the monitor 150 as they are. In this embodiment, two-dimensional images can be fitted to a portion of a screen displayed on the monitor 150.

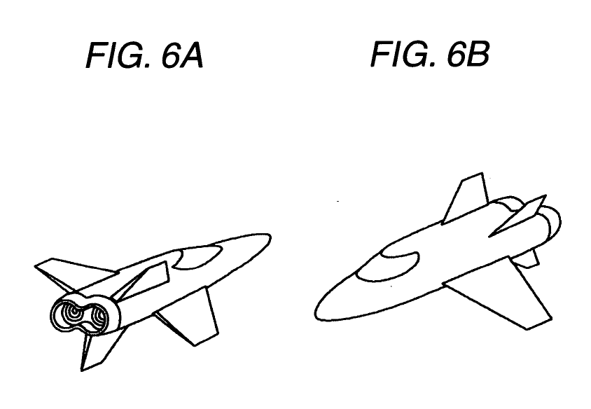

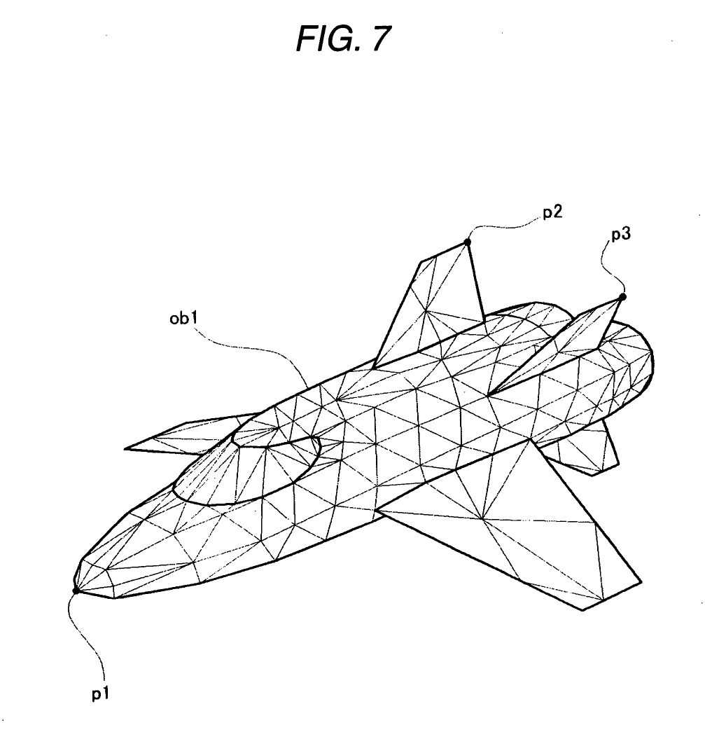

Next, an explanation will be given of a method of dealing with a body as an object having a three-dimensional shape by the game machine 100. As shown in FIGS. 6A and 6B, almost all portions of a surface of the flying boat ob1 are constituted by smooth curved faces. In the game machine 100, the object having the three-dimensional curved faces is expressed by using a plane polygonal shape. That is, the three-dimensional curved face is divided into small plane polygonal shapes and approximately expressed by the plane polygonal shapes as shown in FIG. 7.

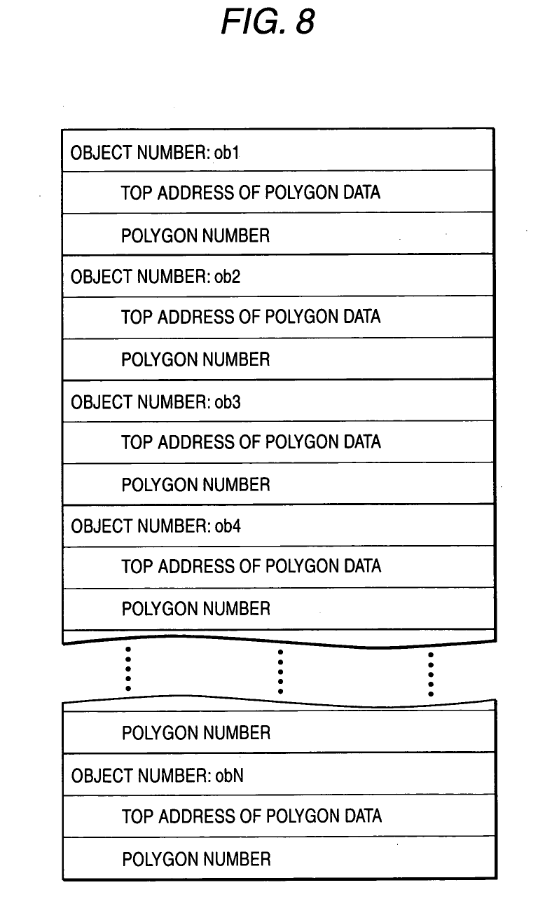

The plane polygonal shape may be referred to as “polygon”. In this embodiment, all of objects are expressed as aggregations of polygons and the shape of the object is expressed by three-dimensional coordinate values of respective apexes constituting the polygon. In the specification, data expressing the shape of the object by coordinates of the apexes of the polygons is referred to as “polygon data”. Further, the polygon data of the respective objects are controlled by a table referred to as object table shown in FIG. 8.

The object table is stored with object numbers for identifying respective objects, top addresses of the main memory 110 stored with polygon data showing shapes of objects and polygon numbers constituting the objects. In the object table, the object number and a record set including the top address of the polygon data and the polygon number are set for every object.

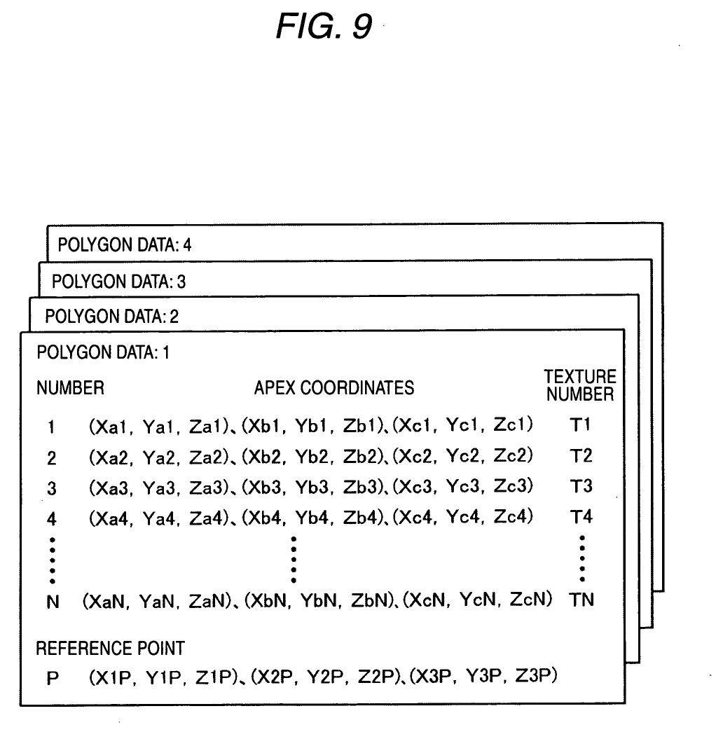

As shown in FIG. 9, the polygon data are constituted by serial numbers of polygons, XYZ coordinate values of apexes constituting the respective polygons, numbers of textures attached to the polygons, XYZ coordinate values of reference points set to the objects. Among them, single sets of the numbers of the polygons, the apex coordinates, the texture numbers are set for the respective polygons, on the other hand, the XYZ coordinate values of the reference points are set with regard to the objects.

Numbers of the apex coordinates set to the respective polygons are set with numbers in accordance with shapes of the polygons. For example, when the polygon is constituted by a triangular shape, the polygon is constituted by three apexes and therefore, the polygon is set with three apex coordinates. Similarly, when the polygon is constituted by a quadrangular shape, four of apex coordinates are set. According to the embodiment, all of the objects are constituted by triangular polygons and therefore, each polygon is set with three apex coordinates.

Further, the texture number can be regarded as a number indicating a color to be painted at inside of the polygon. For example, when a surface of an object is red, all the polygons constituting the object may be painted with red color. In that case, the texture number of the polygon is designated with a number indicating red color. However, not only the colors but also surfaces having various, metallic lusters of aluminum brass and the like, a transparent surface of glass or the like, a surface of wood skin or the like can also be designated as texture numbers. The texture number is a number designating a state of a surface provided to the polygon in this way.

On the other hand, the reference point set to the object is XYZ coordinate values used for expressing a position and an attitude of the object in the three-dimensional space. In this embodiment a screen of the monitor 150 displayed in the midst of the game can be printed as a clear image as if the image were a photograph and although a description will be given later in details, by using information of the position and the direction of the object constituting the object, such a clear image can be printed. Therefore, the object is set with the reference point in order to specify a position in the three-dimensional space at which the object is present and a direction in which object is directed.

With regard to the flying boat (object number ob1) shown in FIG. 7, there are provided a total of three reference points of a reference point P1 provided at an airframe front portion and reference points P2, P3 respectively provided at rear ends of left and right stabilizers. When a minimum of three reference points are provided in this way, the position and the direction of the object in the three-dimensional space can be specified. Naturally, the number of the reference points is not limited to three but a larger number of reference points may be provided. The polygon data shown in FIG. 9 are set with XYZ coordinate values of the reference points. Further, it is not necessarily needed to provide the reference points to all of the objects. With regard to the point, an explanation will be given later in details.

As has been explained above, according to the game machine 100 of the embodiment, all the objects are assigned with the object numbers and surface shapes of the objects are expressed by polygon data indicating the apex coordinates of the polygons. Further, when by citing the object table from the object number, the top address of the corresponding polygon data is acquired, the apex coordinates expressing the three-dimensional space of the object can be acquired by reading data written at and after the address. Image data for displaying on the monitor 150 of the game machine 100 is formed by subjecting the polygon data indicating the three-dimensional shape acquired in this way to a processing, mentioned later.

Further, although according to the object table exemplified in FIG. 8, only two items of the top address of the polygon data and the polygon number constituting the object are set in correspondence with the object number, other items may be set. For example, data indicating a type of the polygon constituting the object, that is, by what angles of a polygon shape a polygon is constituted, whether the reference point is provided to the polygon, data indicating a number of the reference points can be set in correspondence with the object number.

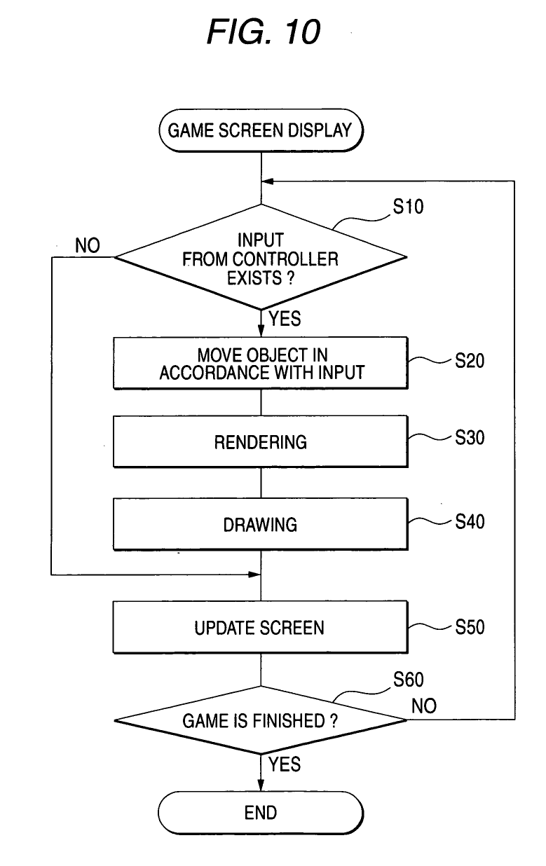

Next, processings executed in corporation with the main memory 110, the GTE 112, the frame buffer 114, the GPU 116 and the like centering on CPU 101 will be described with reference to the flowchart shown in FIG. 10.

When the game screen displaying processing is started, the CPU 101 determines whether there is an input from the controller 102 (step S10). As described above, in the midst of the game, the operation to the game machine 100 is executed exclusively by the controller 102 and therefore, first, it is determined whether there is the operation input from the controller 102. Further, when there is not the input (step S10: No), a processing of updating the display of the screen by outputting the image data stored to the frame buffer 114 to the monitor 150 (screen updating processing) is executed (step S50). The image date to be displayed on the monitor 150 is formed and stored in the frame buffer 114. Contents of a processing for forming the image data to store to the frame buffer 144 and the screen updating processing of outputting the image data stored to the frame buffer 114 to the monitor 150 will be described later. On the other hand, when it is determined that there is the input from the controller 102 (step S10: yes), a series of processings, mentioned later, are executed in order to reflect the content of the operation by the controller 102 on the screen of the monitor 150.

When the input from the controller 102 is detected, a processing of moving the object operated by the controller 102 in the three-dimensional space set as the stage of the game by a distance and in a direction in accordance with the operation is executed (step S20). As an example, an explanation will be given of a case in which the operation by the controller 102 is for advancing the flying boat ob1. As described above, the flying boat ob1 is expressed by the plurality of polygons at inside of the game machine 100 (refer to FIG. 7) and the apex coordinates of the respective polygons are set to the polygon data (refer to FIG. 9). Further, the top address of the memory region stored to the polygon data can be acquired by referring to the object table.

Hence, when the flying boat ob1 is advanced, first, in reference to the object table, the top address of the polygon data in correspondence with the flying boat (object number ob1) is acquired. Next, the apex coordinates constituting the respective polygons are acquired by reading the polygon data stored to the memory region constituting the front acquired address on the main memory 110. The apex coordinates acquired in this way constitute coordinates expressing a position of the flying boat ob1 at a current time point in the three-dimensional space as the stage of the game.

With regard to the point, a more or less supplementary explanation will be given. The storing disk 105 is stored with initial values of the polygon data with regard to the respective objects. Starting the game, the initial values of the polygon data are read from the storing disk 105 and stored to the memory 110 and the top address values storing the polygon data are set to the object table. Further, when the object is moved, rotated or deformed in accordance with proceeding the game, the content of the polygon data stored to the main memory 110 is updated by a processing, mentioned later. Therefore, when the top address is acquired by referring to the object table, the apex coordinates at the current time point of the respective objects can be read.

Here, the controller 102 is operated to advance the flying boat ob1 and therefore, at S20 of the game screen displaying processing shown in FIG. 10, by referring to the object table, the polygon data indicating the current position of the flying boat ob1 is acquired from the main memory 110. Successively, a direction and a moving amount of moving the flying boat ob1 in the three-dimensional space are determined by an amount of operating the controller 102, and the coordinate values of the flying boat ob1 after movement are calculated. The operation is executed at high speed by the GTE 112 under control of the CPU 101. Specifically, when the moving direction and the moving amount of the flying boat ob1 are determined, the CPU 101 supplies the moving direction of the moving amount to the GTE 112 along with the value of the top address of the polygon data. The GTE 112 calculates the apex coordinates after movement by executing coordinates transformation for the apex coordinates of the polygon data after reading the polygon data of the flying boat ob1 based on the supplied top address. The polygon date of the main memory 110 is updated by the apex coordinates after transformation acquired in this way. Although in the above-described, an explanation has been given of the case of advancing the flying boat ob1, when other object is operated by the controller 102, a similar processing is executed for the operated object. As a result, the polygon data of the respective objects stored to the main memory 110 are always stored with the newest coordinate values of the objects.

When the operation of the controller 102 is reflected to the object position in this way, a processing (rendering processing) of forming the data of the two-dimensional image from the polygon data of the respective objects is started (step S30). In the rendering processing, by executing a processing of projecting the three-dimensional objects expressed by the polygon data on a plane in correspondence with the screen of the monitor 150, the two-dimensional image is formed from the three-dimensional objects.

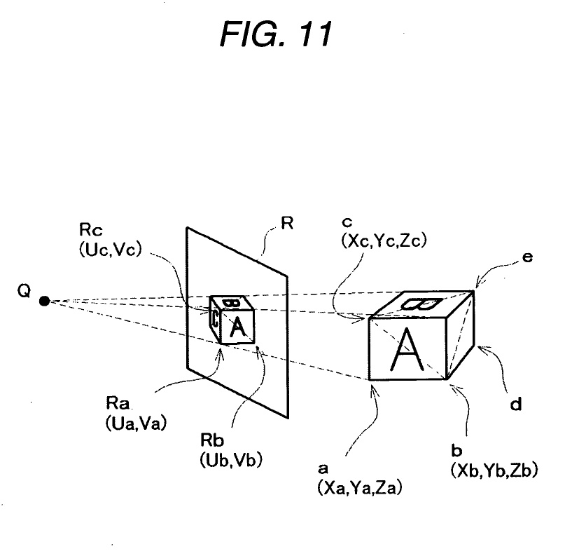

FIG. 11 shows a behavior of forming, a two-dimensional image by subjecting an object in a shape of a dice to the rendering processing. In the rendering processing, first, an observing point Q for observing the object is set, successively, a projecting face R in correspondence with the screen of the monitor 150 is set between the object and the observing point Q. Further, an arbitrary point selected from a surface of the object and the observing point Q are connected by a straight line to determine an intersection at which the straight line intersects with the projecting face R. For example, when point “a” on the object is selected, a point Ra can be determined as an intersection at which a straight line connecting point “a” and the observing point Q intersects with the projecting face R. Here, as is well known, light is provided with a property of advancing straight and therefore, light coming out from point “a” and going to the observing point Q produces an image at point Ra on the projecting face R. In other words, point Ra on the projecting face R can be regarded as a point to which point “a” on the object is projected. Therefore, when such an operation is executed for all of the points on the surface of the object, the two-dimensional image of the object projected onto the projecting face Ra can be acquired.

Incidentally, as described above, the object is expressed by the polygons and therefore, it is not necessary to execute such an operation with regard to all the points on the surface of the object but may be executed only with regard to the apex coordinates of the polygons. For example, assume that point b and point c on the surface of the object are respectively projected to point Rb, point Rc on the projecting face R. In this case, the polygon in a triangular shape constituting apexes by point a, point b, point c on the object may be regarded to be projected to a region in a triangular shape constituting the apexes by point Ra, point Rb, point Rc on the projecting face R. Further, when the polygon on the object is constituted by, for example, red color, also a region in a triangular shape constituted by projecting the polygon onto the projecting face R may be regarded to be constituted by red color. That is, the texture number provided to the polygon on the object can be regarded to be succeeded also to a region projected on the projecting face R.

Further, in the rendering processing, also a processing referred to as so-to-speak shadow face erasing is executed. The shadow face erasing is a processing of erasing a portion of the surface of the object constituting a shade of other surface. For example, in the example shown in FIG. 11, a polygon constituting apexes by point b, point d, point e of the surface of the object is disposed on a back side of the object in view from the observing point Q, a total thereof constitutes a shade of other surface and therefore, an image thereof is not produced on the projecting face R. Hence, with regard to the polygon, a projected image thereof is made not to be displayed on the projecting face R. Further, depending on the shape of the object and setting the observing point Q, there is also a case in which only a region of a portion of a certain polygon constitutes a shade of other surface. In such a case, a display of only a portion of the polygon constituting the shade is omitted and the projected image is displayed only for a portion which does not constitute a shade.

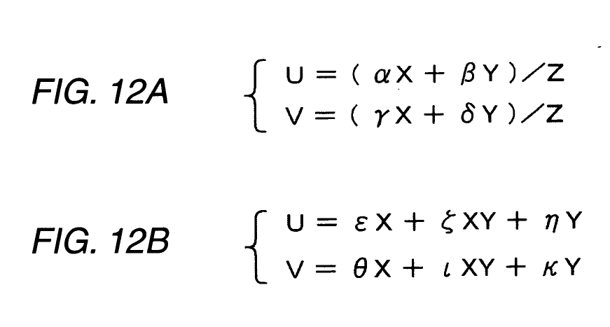

In this way, in the rendering processing, a processing of calculating coordinate values when the apexes of the polygons constituting the object are projected onto the projecting face R. Such coordinate values can comparatively simply be calculated. FIG. 12A shows a calculation equation for calculating coordinate values (U, V) on the projecting face R provided by projecting coordinate points (X, Y, Z) on the object. Here, α, β, γ, δ are coefficients determined by a distance from the observing point Q to the projecting face R, or to the object. Or, simply, a calculation equation which does not include a division can also be used as shown by FIG. 12B. Here, ε, ζ, η, θ, ι, κ are coefficients respectively determined by a distance from the observing point Q to the projecting face R, or to the object.

Further, although a detailed explanation will be omitted, in the rendering processing, there may be carried out a processing referred to as shading for shading the surface of the object by placing a light source at a previously set position in the three-dimensional space, or a processing or reducing a brightness at a remotely disposed portion or gradating a projected image in order to emphasize a depth perception. The rendering processing comprising such a series of processings is executed by receiving an instruction from the CPU 101 by the GTE 112, executing predetermined operation to the polygon data stored to the main memory 110 and updating the polygon data on the memory by using a provided result. Further, when the above-described processings are executed for all the objects appearing on the screen of the monitor 150, the rendering processing indicated at step S30 of FIG. 10 is finished.

Successive to the above-described rendering processing, the CPU 101 of the game machine 100 starts a drawing processing (step S40 of FIG. 10). The drawing processing is a processing of forming the image data set with gray scale values for respective pixels from the projected image formed by the rendering processing. That is, the projected image provided by the rendering processing is expressed by a style using coordinates of apexes of polygonal shapes projected with polygons and texture numbers to be provided to the polygonal shapes. On the other hand, the image data which can be displayed on the monitor 150 is expressed by a style finely dividing the image into small regions referred to as pixels and set with gray scale data (normally, data expressing brightness) for the respective pixels. When one kind of brightness data is set to each pixel, the image data becomes the image data of a monochromatic image and when brightness data of respective colors of RGB constituting three primary colors of light is set, the image data becomes an image data of a color image. Further, in place of the brightness data of respective colors of RGB, a color image can also be expressed by using two kinds of gray scale data in correspondence with brightness of color and gray scale data in correspondence with chrominance. At any rate, data expressing the projected image provided by the rendering processing cannot be displayed on the monitor 150 as it is and therefore, a processing of converting the data into a data style which can be displayed on the monitor 150 is executed. Such a processing is a processing referred to as drawing processing. Further, as described by using FIG. 5, when two-dimensional image is fitted to the screen, data of the two-dimensional image may be fitted thereto in the drawing processing.

When the drawing processing is started, the CPU 101 of the game machine 100 outputs a drawing instruction to the GPU 116. The drawing processing is executed by forming the image data to store to the frame buffer 114 by the GPU 116 by receiving the drawing instruction.

As described above, the projected image constituting the object of drawing is the two-dimensional image provided by projecting polygons constituting the object onto the projecting face R. In this embodiment, the object is constituted by using polygons all of which are formed by the triangular shape and therefore, as a rule, all the polygons are projected onto the projecting face R as an image of the triangular shape.

Further, polygon indicates a plane polygonal shape constituting the object as described above, strictly speaking, the polygonal shape constituted by projecting the polygon to the projecting face R differs from the polygon. However, in the following, for convenience of explanation, also the projected image of the polygon is referred to as polygon. Further, in differentiating these, the polygons may be referred to as “polygon constituting object”and “polygon constituting projected image”.

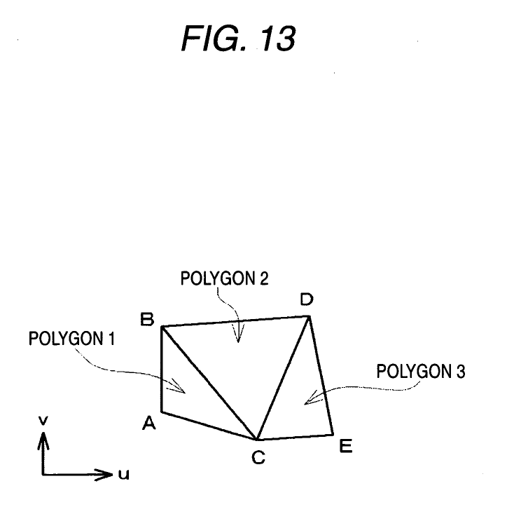

The projected image shown in FIG. 13 is constituted by three polygons of polygon 1, polygon 2, polygon 3. Further, all of projected images are constituted by triangular polygons to correspond to that all polygons constituting the object are constituted by triangular polygons and when the triangular polygons are projected to the projecting face R, triangular projected images are provided. Further, as described above in reference to FIG. 11, polygons constituting the projected images are attached with texture numbers the same as those of polygons constituting the object.

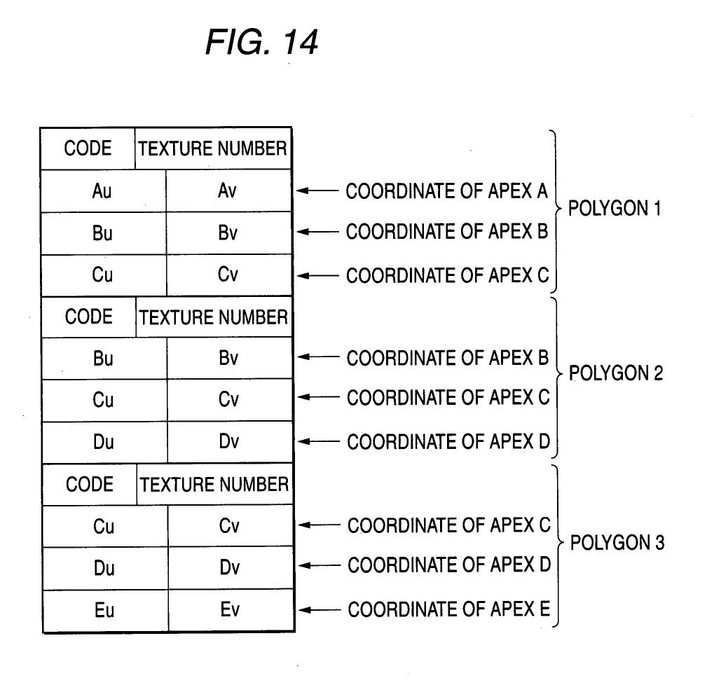

When the projected image is drawn, the CPU 101 outputs the drawing instruction having a data structure shown in FIG. 14. As illustrated, the drawing instruction is constituted by data sets each of which includes “CODE”, texture numbers, coordinate values of apexes on the projected face R for each of polygons. Here, “CODE” expresses that the instruction is the drawing instruction and becomes data for indicating a shape of the polygon constituting the object of drawing. That is, there is also a case in which the polygon constituting the object is not limited to the triangular shape but a polygon of a quadrangular shape or a pentagonal shape or the like is used, in accordance therewith, a shape of the polygon constituting the projected image is also changed. Further, even when the polygon of the object is constituted by the triangular shape, in a case where a portion thereof constitutes a shade of other polygon, the polygon on the projected race R can also be dealt with as a polygon of, for example, a quadrangular shape. In consideration thereof, according to the drawing instruction of the embodiment, a shape of the polygon is made to be able to be designated for each polygon.

The drawing instruction of the embodiment is set with the texture number successive to “CODE”. The texture number is a texture number attached to a polygon constituting the projected image and in almost all the cases, the texture number the same as the texture number attached to the polygon constituting the object. Further, in place of the texture number, color information (for example, gray scale values of respective colors of R, G, B) to be attached to the polygon can also be set.

Successive to the texture number, coordinate values on the projected face R of apexes constituting the polygons are set. A number of apex coordinates is determined by “CODE”, mentioned above. For example, when the shape of the polygon is designated as the triangular shape, in “CODE”, three apex coordinates are set and when designated to a polygon of a quadrangular shape, four apex coordinates are set. The drawing instruction is constituted by a data structure in which data constituting single sets of “CODE”, the texture numbers, the apex coordinates are set for respective polygons constituting the projected image.

According to the drawing instruction exemplified in FIG. 14, three sets of data comprising “CODE”, the texture numbers and the apex coordinates are set in correspondence with that the projected image constituting the object of drawing is constituted by three polygons of polygon 1 through polygon 3. That is, with regard to polygon 1, successive to “CODE” and the texture number, coordinate values of three apexes A, B, C constituting polygon 1 are set. Further, with regard to polygon 2, successive to “CODE” and the texture number, coordinate values of three apexes B, C, D constituting polygon 2 are set, with regard to polygon 3, successive to “CODE”, the texture number, coordinate values of three apexes C, D, E constituting polygon 3 are set. The apex coordinates and the texture numbers of the polygons are stored to the main memory 110 after having being generated by the GTE 112 in the above-described rendering processing. The CPU 101 generates the drawing instruction having the data structure shown in FIG. 14 to supply to the GPU 116 by reading the data with regard to all the objects to be displayed on the screen of the monitor 150 from the data stored in the main memory 110.

When the GPU 116 receives the drawing instruction, the GPU 116 converts insides of the polygonal shapes constituted by connecting the respective apexes to the two-dimensional image printed by the color or the pattern indicated by the texture number. Further, the provided two-dimensional image is converted into data of an expressing style setting the gray scale data for the respective pixels constituting the image to store to the frame buffer 114 as the image data. As a result, the projected image expressed by the apex coordinates of the polygons on the projected face R and the texture numbers of the polygons is converted into the image data in a data style which can be expressed on the monitor 150 to be stored to the frame buffer 114. Further, the image data set with the gray scale values of respective colors of R, G, B at the respective pixels is formed. When the above-described processing is executed for all the projected images appearing on the screen of the monitor 150, the drawing processing shown in step S40 of FIG. 10 is finished.

When the drawing processing has been finished, at this occasion, a processing of updating the screen of the monitor 150 by outputting the image data provided on the frame buffer 114 to the monitor 150 is executed (step S50). That is, in accordance with the specification of the monitor 150 such as a screen resolution or a scanning system of interlace or non-interlace or the like, the image data is read from the frame buffer 114 to supply to the monitor 150 as a video signal. Thereby, the two dimensional image developed to the frame buffer 114 can be displayed on the screen of the monitor 150.

Further, when the displaying of the monitor 150 is updated by a frequency of at least 24 times or more per second, by the after image phenomenon provided to the retina of the human being, the image as if it were continuously moved can be displayed. In this embodiment, by updating the display of the screen by executing the game screen displaying processing shown in FIG. 10 at a frequency of about 30 times per second, the display can be executed as if the various objects of the flying boat ob1 and the like is continuously moved in the screen of the monitor 150. Further, in order to be able to execute such a high speed processing, the game machine 100 of the embodiment is mounted with the GTE 112 capable of executing various operations including coordinates transformation at high speed, the main memory 110 capable of reading and writing a large amount of data used in the operations at high speed, the GPU 116 swiftly generating image data based on the drawing instruction received from the GPU 101, further, the frame buffer 114 or the like capable of storing the generated image data at high speed and outputting the data to the monitor 150 at high speed.

Incidentally, when a number of polygons constituting the object of the processing becomes successively large, it is difficult to execute the game screen displaying processing shown in FIG. 10 at a frequency of about 30 times per second. Hence, the various objects including the flying boat ob1 are constituted by more or less large polygons such that a number of the polygons is not excessively large. As described above, the polygon is constituted by a plane polygonal shape and therefore, when the polygon becomes successively large, there is brought about a drawback that a surface of the object becomes angular. However, fortunately, on the screen of the game, the object is frequently moved, in addition thereto the monitor 150 is not provided with a high drawability as in a photograph and therefore, it is hot conspicuous that a surface of the object is angular and therefore, there is not brought about a drawback that a feeling of presence of the game is deteriorated.

However, when the screen of the monitor 150 is printed by a printing apparatus, such a situation is changed at all. That is, in addition to the fact that the image provided by printing is a stationary image, a printing apparatus in recent years is provided with a high drawability near to that of a photograph and therefore, there is a case in which it is found that a surface of the object is angular by seeing the printed image. Further, after seeing the printed image, even in the object displayed on the monitor 150 in the midst of the game, the surface looks to be angular and there is a concern that the feeling of presence of the game is significantly deteriorated. In contrast thereto, according to the game machine 100 of this embodiment, even when the screen of the monitor 150 is printed by a printing apparatus, a clear image as if a real object were taken by a photograph can be outputted. In view of the point according to the game machine 100 of the embodiment, the following processing is executed to be able to further accurately grasp the printed image from the monitor 150.

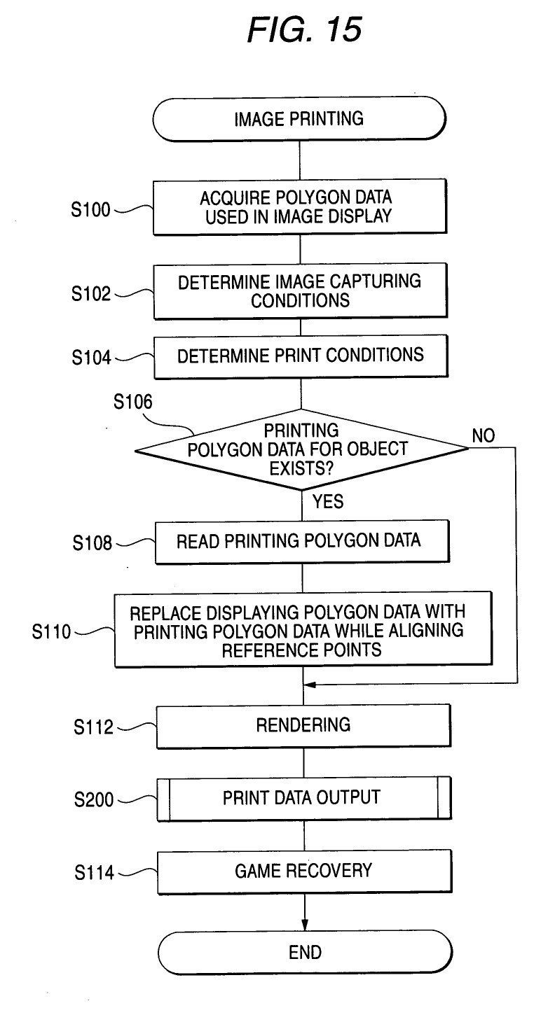

The image printing processing will be described with reference to the flowchart shown in FIG. 15.

When detecting that a printing button installed in the controller 102 is pressed, the CPU 101 of a game machine 100 generates an interruption and starts an image printing processing shown in FIG. 15. When the interruption is generated, the processes executed hitherto by the CPU 101 are stopped and the progress of a game is accordingly stopped until the image printing processing is finished.

When the image printing processing is started the CPU 101 first acquires polygon data (displaying polygon data) as a source of an image displayed on the monitor 150 at the time when the printing button of the controller 102 is pressed (step S100). That is, as described above, the image displayed on the monitor 150 is an image obtained by projecting an object onto the projecting face R and coordinate values of vertexes of polygons constituting the object are stored as the polygon data in the main memory 110. Accordingly, in step S100, the displaying polygon data used for displaying objects displayed on the monitor 150 at the time when the printing button of the controller 102 is pressed are acquired.

Next, a processing of setting image capturing conditions is started (step S102). That is, in the game machine 100 according to the present embodiment, it is possible to form a printed image as if a photograph is taken with a camera, as well as to print the image displayed on the monitor 150 simply with the color printer 200. In step S102, the processing of setting the image capturing conditions is performed in the game machine 100. The setting of the image capturing conditions can be performed by an operator while the operator checks an image displayed on the monitor 150.

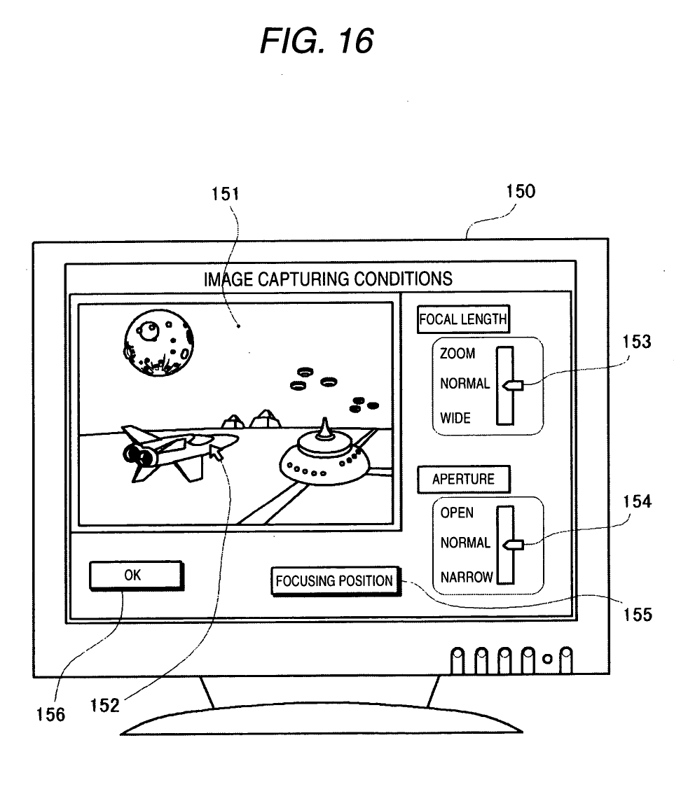

As shown in FIG. 16, substantially a center of the screen for setting the image capturing condition is provided with a monitor region 151 for displaying the screen displayed on the monitor 150 when a printing button is depressed. Further, a periphery of the monitor region 151 is provided with buttons for setting a focal length, an aperture value, a focusing position and the like. In this embodiment, a screen displayed on the monitor 150 is not simply printed but by setting the items, thereby, the image on the monitor 150 can be printed as if a photograph were taken by operating a virtual camera.

A focal length is set by selecting focal lengths from zoom to wide angle by moving a knob 153 provided on a right side, of the monitor region 151 in an up and down direction. Further, the aperture value is set by selecting a value from an open side to a narrow side by moving a knob 154 provided on the right lower side of the monitor region 151 in the up and down direction. Further, the focusing position can be set by moving a cursor 152 displayed on the monitor region 151 while operating a cross cursor of the controller 102 to a position intended to focus and thereafter depressing a button displayed as “focusing position” on the set screen. An effect of the image capturing condition set in this way is reflected to the image displayed on the monitor region 151 and therefore, the image capturing condition can be set while confirming the effect. Further, when a desired image capturing condition is determined, by depressing a button 156 displayed as “OK” on the set screen, the set image capturing condition is firmly determined and a processing of confirming the printed image reflected with the image capturing condition is started. At step S102 of the printed image confirming processing shown in FIG. 15, the processing of setting various image capturing conditions is executed as described above.

When the image capturing conditions have been set, the CPU 101 of the game machine 100 subsequently starts a processing of setting printing conditions (step S104). The processing of setting the printing conditions can be performed by the operator of the game machine 100 while checking an image displayed on the monitor 150, similarly to the processing of setting the image capturing conditions in step S102 described above.

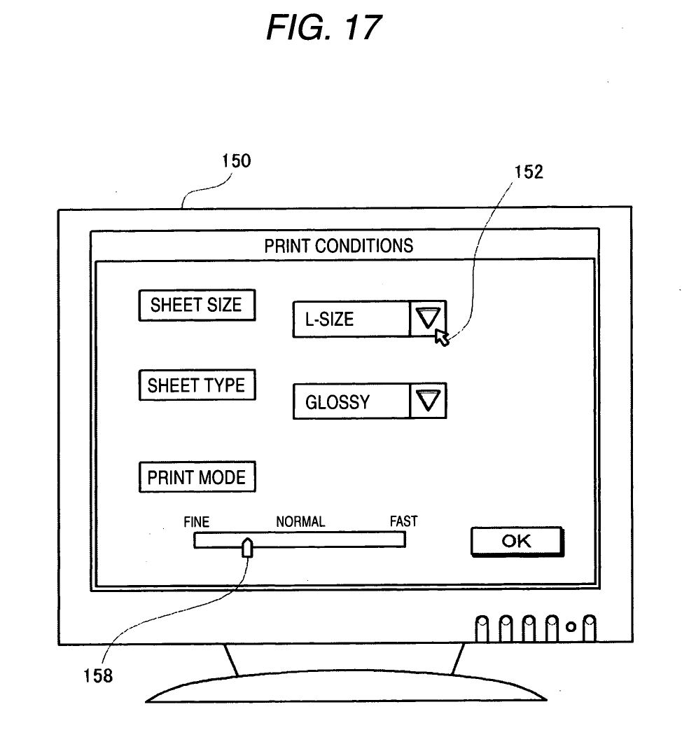

As shown in FIG. 17, three items of a sheet size, a sheet kind, and a printing mode used for a printing processing can be set as the printing conditions. Here, the printing mode is a mode for setting whether preference is given to a printing speed or a printing quality at the time of printing. That is, since a trade-off relation generally exists between the print speed and the print quality, the high-speed printing deteriorates the image quality and the high-quality printing lengthens a printing time. Accordingly, specifically when the high-speed printing is desired or when the high-quality printing is desired, it is possible to performing the desired printing by setting the printing mode to “fast” or “fine.”

The sheet size and the sheet kind are set by selecting the sheet size by using the cursor 152 displayed on the screen by operating the cross cursor of the controller 102. Further, the printing mode can be set by moving a knob 158 displayed on the screen from “fine” to “fast”. Further, in addition to the conditions, items of a number of sheets of printing and whether so-to-speak marginless printing is executed may be able to be set. When the printing condition is set as described above, by depressing a button displayed as “OK” on the set screen, the set printing condition is firmly determined.

When the image capturing conditions and the printing conditions for an image displayed on the monitor 150 have been set in this way, it is determined whether printing polygon data are stored (step S106). Here, the printing polygon data are data for expressing a three-dimensional image of an object by the use of polygons smaller than the polygons used for the above-mentioned processing of displaying the game image.

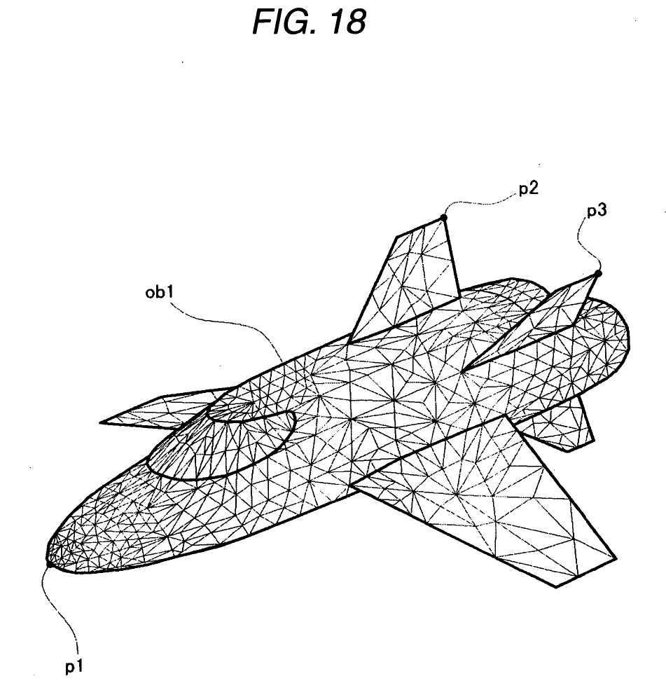

Comparing FIG. 7 with FIG. 18, it can be seen that the printing polygon data uses polygons smaller than those of the polygon data used for the processing of displaying the game image. As the curvature of the surface of a portion of an object becomes greater (the radius of curvature becomes smaller), the portion is composed of the small polygons. In this way, by using the small polygons, the shape of an object can be expressed more accurately. Accordingly, it is possible to prevent a portion having a great surface curvature from giving a angular impression to a viewer.

A plurality of reference points (three in the present embodiment) are provided in the printing polygon data, similarly to the general polygon data (displaying polygon data) used for displaying an image shown in FIGS. 7 and 9. The reference points are disposed at the same positions in the positional relation of the object in the printing polygon data and the displaying polygon data. For example, as shown in FIG. 7, in the displaying polygon data of the flying boat ob1, the reference points P1, P2, and P3 are disposed at the front end and the rear ends of left and right tails of the plane body. Similarly, in the printing polygon data of the flying boat ob1, the reference points P1, P2, and P3 are disposed at the front end and the rear ends of left and right tails of the plain body. As for an object having the printing polygon data, the reference points are disposed at the same positions of the object in the displaying polygon data and the printing polygon data. In other words, the reference points are not necessarily disposed in object data of an object not having the printing polygon data.

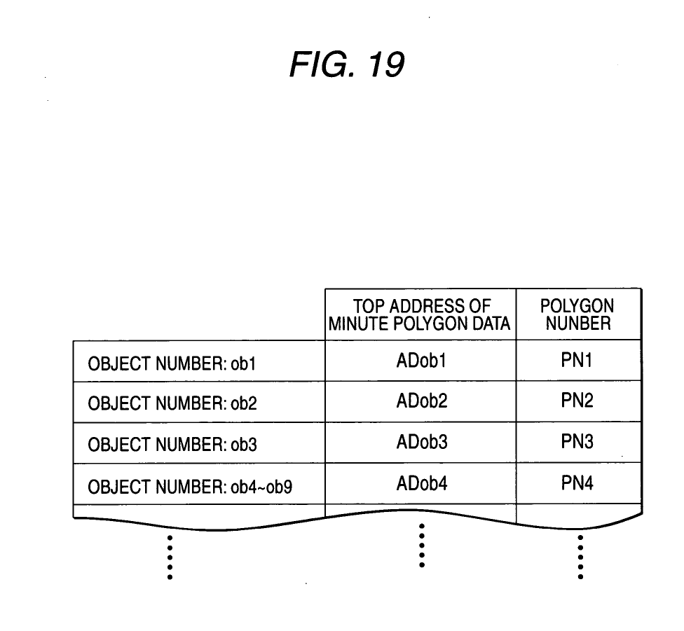

It can be determined whether the minute polygon data is existed by referring to a table (printing polygon data table) previously set with presence or absence of the printing polygon data. As shown in FIG. 19, the printing polygon data table is set with an object number of the object in which the printing polygon data is existed and a polygon number. Therefore, when the object number is set by referring to the printing polygon data table, it can be determined that the printing polygon data is existed with regard to the object. Conversely, when the object number is not set to the printing polygon data table, it can be determined that the printing polygon data is not existed with regard to the object.

Further, the object table described above in reference to FIG. 8 is set with the inherent object numbers and the top addresses of the polygon data with regard to all the objects. On the other hand, according to the printing polygon data table, there is a case in which the same top address is set to a plurality of the object numbers. For example, as shown by FIG. 4, all of the objects of objects ob4 through ob9 express the flying circular disks and the flying circular disks are constituted by the same shape. In such a case, in the printing polygon data table, as shown by FIG. 19, with regard to the six objects having the object numbers ob4 through ob9, the same top address and the same polygon number are set. A description will be given later of a reason that in the printing polygon data table, there is a case in which the same top address and the polygon number are set to different object numbers.

In step S106 shown in FIG. 15, as for the objects of which the printing polygon data exist, the printing polygon data are read with reference to the printing polygon data table shown in FIG. 19 (step S108). The read printing polygon data are stored in the successive addresses of the main memory 110. Next, the reference points of the displaying polygon data acquired in step S100 are matched with the reference points of the read printing polygon data, and then a processing of replacing the displaying polygon data with the printing polygon data is performed (step S110). Hereinafter, details of this processing will be described. It is assumed that the read printing polygon data are stored in an area successive to an address value Appd in the main memory 110.

First, by performing coordinate conversion of moving or rotating the objects with respect to the read printing polygon data, the coordinates of the reference points of the printing polygon data are matched with the coordinates of the reference points of the displaying polygon data. Such coordinate conversion is performed not to data indicated by the head address of the printing polygon data table shown in FIG. 19, but to data developed successive to the address Appd of the main memory by reading the printing polygon data. When the coordinates of the reference points of the printing polygon data are matched with the coordinates of the reference points of the displaying polygon data, the head address and the number of polygons of the object table described with reference to FIG. 8 are replaced with the head address Appd of the memory area in which the printing polygon data are stored and the number of polygons constituting the printing polygon data, in the main memory 110.

In this way, by replacing the head address and the number of polygons set in the object table, the printing polygon data, not the displaying polygon data, are referred to in a rendering processing and an imaging processing performed subsequently. In step S110 of FIG. 15, the processing of replacing the displaying polygon data with the printing polygon data is a processing of replacing the head address and the number of polygons set in the object table with the head address and the number of polygons of the positioned printing polygon data.

Herein, as shown in FIG. 19, the reason for setting the same head address and the same number of polygons with respect to different object numbers in the printing polygon data table will be described. As described above, as for the object of which the printing polygon data exist, the printing polygon data are read and then the printing polygon data are moved or rotated such that the coordinates of the reference points are matched with the coordinates of the reference points of the displaying polygon data. Here, the different objects necessarily have different three-dimensional coordinate values. Accordingly, even when the printing polygon data have been read from the same address value, the different printing polygon data are obtained after the movement or rotation. Therefore, when such a processing is performed in different areas of the main memory 110 every object, the same data can be used as the original printing polygon data. As a result, in the printing polygon data table, the same head address and the same number of polygons are set with respect to the objects having the same shapes.

On the other hand, the printing polygon data are not stored for all the displaying polygon data and the displaying polygon data which are replaced with the printing polygon data are a part of the polygon data. That is, the polygon data having been subjected to the replacement includes both of the displaying polygon data and the printing polygon data. Accordingly, such polygon data are referred to as precise polygon data, hereinafter.

In this way, as for the objects of which the printing polygon data exist, the displaying polygon data are replaced with the printing polygon data to generate the precise polygon data, and then a rendering processing is performed (step S112). As described above, the rendering processing is a processing of generating two-dimensional image data from the polygon data of each object.

Such a rendering processing can be performed, as described with reference to FIG. 11, by calculating a viewing point Q and an image projected to the projecting face R set with respect to the respective objects. Since the rendering processing has been described with reference to FIGS. 11 to 12B, the description thereof is omitted herein. However, the details set in the processing of setting the image capturing conditions are reflected in setting the viewing point Q and the projecting face R in the rendering process. The objects apart from or close to the viewing point Q may be subjected to special operations such as a filtering processing of blurring the projected image, depending upon the setting of the aperture value.

Similarly to the processing of displaying the game image described with reference to FIG. 10, the rendering processing is performed by the GTE 112 under the control of the CPU 101 while referring to the object table and the acquired two-dimensional image data are stored in the main memory 110. In step S106, as for the objects of which the printing polygon data exist, since the object table (see FIG. 8) is rewritten in step S110 subsequent thereto, the rendering processing performed in step S122 of FIG. 15 is performed not to the displaying polygon data displayed on the monitor 150 when the printing button of the controller 102 is pressed, but to the minute polygon data in which a part of the displaying polygon data are replaced with the printing polygon data.

When the rendering processing is finished, a processing of reading the data stored in the main memory 110 and outputting the read data as print data to the color printer 200 is started (step S200). The print data outputting processing will be described later in detail, but the following operations are performed in brief.

First, the data acquired through the rendering processing are data indicating the coordinate values of the vertexes of the two-dimensional polygons projected to the projecting face and texture numbers to be given to the polygons. However, since the color printer 200 receives the data with the format expressed by gradation data by pixels, the data acquired through the rendering processing should be developed as data with the format expressed by the gray scale data by pixels by performing the imaging process, similarly to the processing of displaying the game image described with reference to FIG. 10. The gray scale data by pixels developed in this way are stored in the frame buffer 114, similarly to displaying an image.

As described above, since the displaying polygon data are replaced with the printing polygon data at the time of printing the image, the number of polygons is increased. Accordingly, due to the memory capacity of the frame buffer 114, all the polygon data cannot be developed at a time, but should be developed plural times. Therefore, in the processing of outputting the print data (step S200 of FIG. 15), the data acquired by performing the rendering processing to the minute polygon data are a first read as many as the number of polygons from the main memory 110, are subjected to the imaging process, and then are developed in the frame buffer 114. After the acquired data are output as the print data to the color printer 200, the data having been subjected to the rendering processing are read again as many as a predetermined number of polygons from the main memory 110 and are developed in the frame memory 114. By repeating this process, the processing of outputting the print data to the color printer 200 is performed while gradually performing the imaging processing within the restricted range to the memory capacity of the frame buffer 114. Details of the print data outputting processing will be described later.

When all the print data are output to the color printer 200, the print data outputting processing is ended and the image printing processing shown in FIG. 15 is performed again. Subsequently, in the image printing process, a game restart processing is performed (step S114). The game restart processing is a processing performed to end the image printing processing and to restart the game. That is, when the printing button of the controller 102 is pressed as described above, the above-mentioned image printing processing is started in the state that the CPU 101 of the game machine 100 generates an interruption to stop the game in play. Accordingly, before ending the image printing process, the CPU 101 performs the preparation for restarting the game by returning the program counter or various data to the states before stopping the game. As described above, as for the objects of which the minute polygon data exist, since the set values of the object table are rewritten during the image printing process, the set values are returned to the original set values due to the game restarting process.

In this way, when the game restarting processing is ended (step S114), the image printing processing shown in FIG. 15 is ended. Since various variables and data such as program counter are returned to the state before stopping the game, the game can be restarted from the stopped portion.

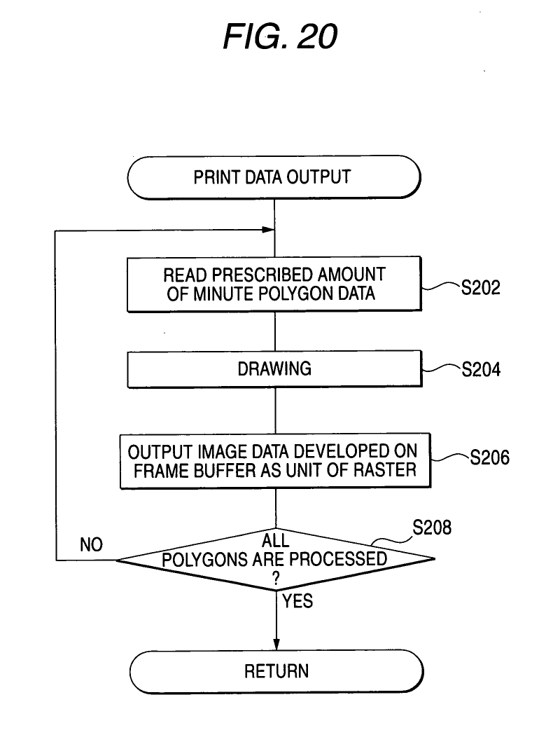

Next, the print data outputting processing will be explained with reference to a flowchart shown in FIG. 20. This processing is performed by the CPU 101 among the image printing processing described with reference to FIG. 15.

When the print data outputting processing is started, a processing of reading the minute polygon data as many as the predetermined number of polygons from the main memory is first performed (step S202). That is, since the imaging command cannot be performed to all the polygons included in the minute polygon data due to the restriction to the memory capacity of the frame buffer 114, the data of the polygons are read by the predetermined number as follows so as to perform the imaging command within the allowable range of the memory capacity.

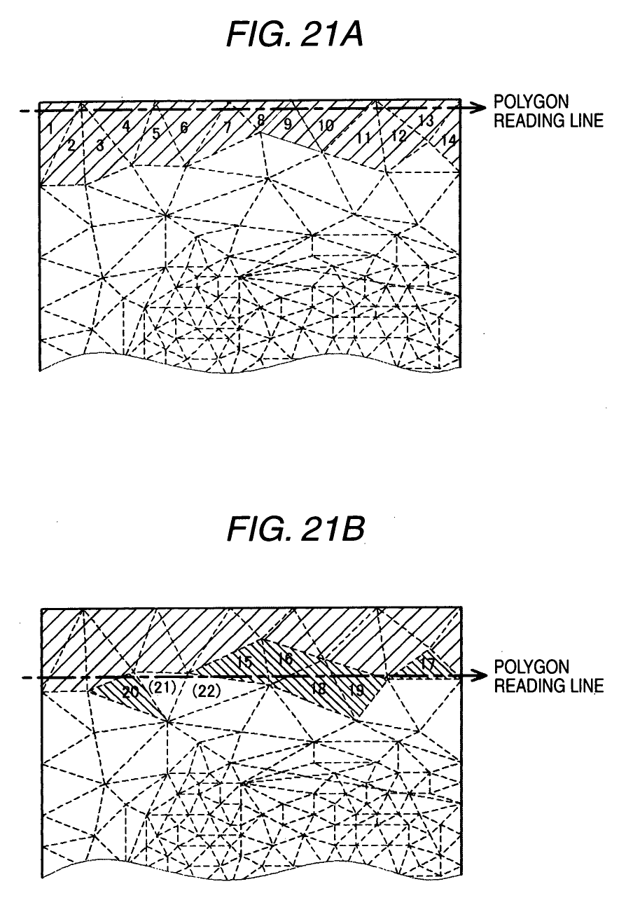

As described above with reference to FIG. 15, in the rendering processing performed before the print data outputting processing, data of polygons constituting a two-dimensional projected image are generated from data of polygons constituting a three-dimensional object and are stored in the main memory 110. Triangles indicated by dashed lines in FIGS. 21A and 21B conceptually illustrate the polygons constituting the projected image generated through the rendering process. Real images are expressed by relatively small polygons, but for the purpose of avoidance of complex illustration, the images are expressed by relatively large polygons.

Areas including only the relatively small polygons and areas including only the relatively large polygons exist in FIGS. 21A and 21B. This is because a part of the displaying polygon data are replaced with the printing polygon data in the image printing processing described above and the acquired minute polygon data are subjected to the rendering process. That is, the areas including only the small polygons in the figure conceptually show that they are generated by performing the rendering processing to the object expressed by the printing polygon data. The areas including only the large polygons conceptually show that they are generated by performing the rendering processing to the object expressed by the displaying polygon data.

In the processing (step S202) of reading the polygon data in the print data outputting processing shown in FIG. 20, a polygon reading line is set and the processing of reading the polygon data by a predetermined number of polygons while moving the setting position of the reading line is performed. In FIG. 21, the polygon reading line is indicated by a chain line. The polygon reading line is first set at the upper end of an image and the reading line is sequentially moved downwardly as the reading of the polygon data is advanced. This is because the printing of images are performed from the upper end to the lower end in the color printer 200 for actually printing an image.

FIG. 21A conceptually shows a state that the polygon reading line is set at the upper end of the image right after the print data outputting processing is started. In the processing of reading the minute polygon data, the polygons through which the set reading line passes are detected and the data of the detected polygons are read. In the examples shown in FIG. 21A, the read polygons are hatched. For the purpose of convenience of description, the polygons are denoted by numbers indicating the order of reading the polygons. As can be apparently seen from the number denoting the polygons, the date of 14 polygons are read at the position of the reading line set in FIG. 21A.

An upper limit exists in the number of polygons which can be read. When the imaging command is performed to the read polygon data, the image data changed to the gray scale data by pixels are developed in the frame buffer 114. Accordingly, when the number of polygons becomes too great, the image data cannot be developed due to the restriction to the memory capacity of the frame buffer 114. Practically, the readable number of polygons is set to a sufficient number of polygons so as to constitute one image to be displayed on the monitor 150 during the game image displaying processing shown in FIG. 10, but for the purpose of convenience of description, it is assumed herein that the readable number of polygons is “20.”

When the polygon reading line is set to the position shown in FIG. 21A, the number of polygons to be read is 14 and thus data of 6 polygons can be further read later. Accordingly, the data of 20 polygons are read while the position of the reading line is gradually moved downwardly and data of new polygons are read. FIG. 21B conceptually shows a state that the data of 20 polygons are read. That is, when the position of the polygon reading line is gradually lowered from the position shown in FIG. 21A, data of the polygons denoted by “15”, “16”, and “17” in FIG. 21B are read. When the polygon reading line is further lowered, data of the polygons denoted by “18” and “19” are read. When the polygon reading line is lowered to the positions shown in FIG. 21B, data of the polygon denoted by “20” are read. A polygon denoted by “21” and a polygon denoted by “22” exist in the polygon reading line. However, since the number of read polygons reaches “20”, the reading of data is not performed to the two polygons. In step S202 of performing the print data outputting processing shown in FIG. 20, the processing of reading the minute polygon data by a predetermined number of polygons (20 in the example shown in FIG. 21) is performed.

In this way, by performing the imaging processing to the read polygon data, the image data developed in the form of the gray scale data by pixels are stored in the frame buffer 114 (step S204). Since the details of the imaging processing have been described with reference to FIGS. 13 and 14, the description thereof is omitted herein.

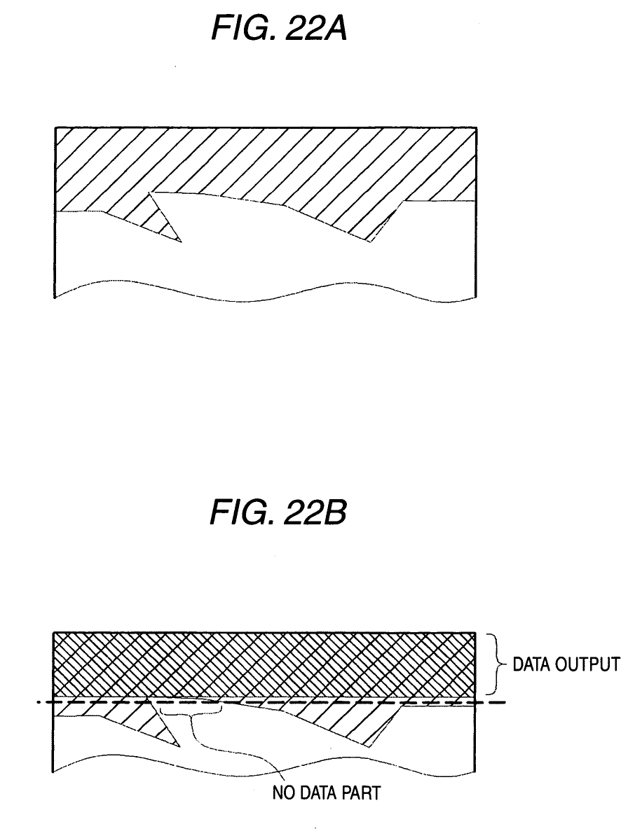

Next, a processing of outputting the image data developed in the frame buffer 114 to the color printer 200 in a unit of raster is performed (step S206 of FIG. 20). When the imaging processing is performed to the polygon data read by the predetermined number of polygons, gray scale data corresponding to the texture number of each polygon are given to the pixels included in each polygon and are developed in the frame buffer 114. FIG. 22A conceptually shows the state that the image data are developed in the frame buffer 114. Here, since it is assumed that the polygons hatched in FIG. 21B are read, the image data are developed for the pixels in the area in which the polygon exists.

Next, the developed image data are read from the pixels located at the upper end of the image line by line and are output to the color printer 200. That is, the image data corresponding to one line of pixels at the upper end of the image are read and output to the color printer 200. Next, the image data corresponding to the second line of pixels from the upper end are read and output to the color printer 200. Next, the image data corresponding to the third line of pixels from the upper end are read and output. Such a line of pixels is referred to as raster. Therefore, the image data developed in the frame buffer 114 are output to the color printer 200 in a unit of raster.

The finely hatched area in FIG. 22B is an area from which the image data can be output in a unit of raster. The raster (indicated by a dashed line in the figure) below the area by one line includes the pixels of which the image data are not developed and thus image data cannot be output in a unit of raster. Therefore, in step S206 of FIG. 20, until such a raster that the image data are lacked appears, the processing of reading the image data developed in the frame buffer 114 in a unit of raster and outputting the read image data as the print data to the color printer 200 is performed.

In this way, when the image data in a unit of raster are output as the print data, it is determined whether the processings are finished for the all polygons of the minute polygon data having subjected to the rendering processing (step S208). When it is determined that the not processed polygons remain (step S208: NO), step S202 is performed again and thus the image data are newly read by the predetermined of polygons from the minute polygon data stored in the main memory 110.

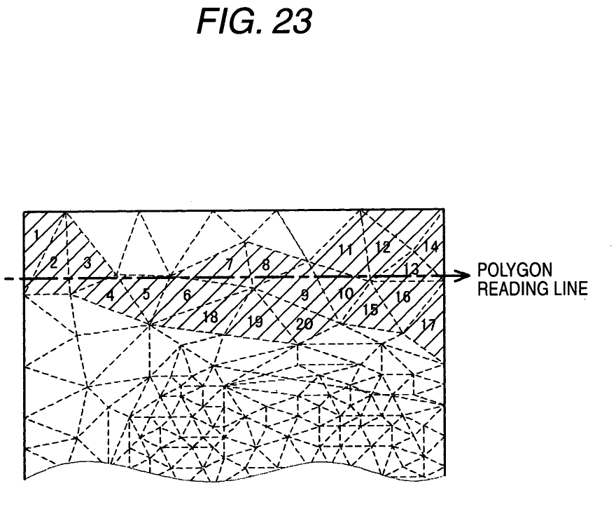

As described above, when the polygon data are read, a polygon reading line is first set. Here, since the polygon data are read in the previous process, the reading of the new polygon data is performed from the position of the set polygon reading line. The polygon reading line indicated by a chain line in FIG. 23 indicates a position (that is, the position shown in FIG. 21B) where the polygon reading line is set latest in the previous process.

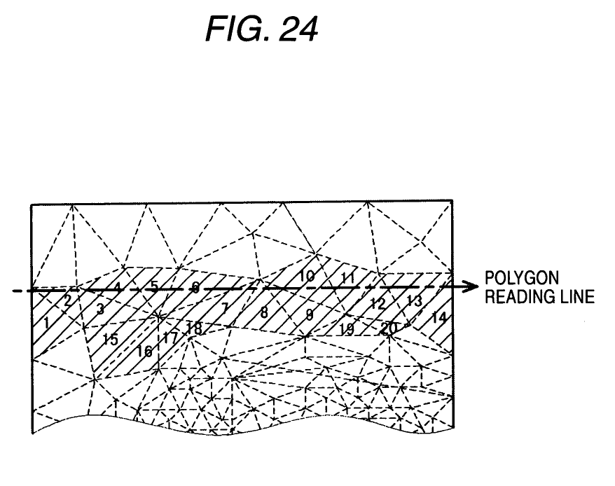

Then, the polygons through the polygon reading line passes are detected and the polygon data corresponding to the detected polygons are read. When the number of read polygons is less than the predetermined number (here, 20), the position of the polygon reading line is lowered and then the polygon data are read by the predetermined number of polygons. In this way, the polygon data corresponding to the hatched polygons in FIG. 23 are read from the main memory 110. Next, the imaging processing is performed to the polygon data (step S204 of FIG. 20), the image data developed in the frame buffer 114 are read in a unit of raster and are output as the print data to the color printer 200 (step S206), and then it is determined whether the all polygons are processed (step S208). When it is determined that the polygons not processed remain (step S208: NO), step S202 is performed again and thus new polygon data are read. As a result, the polygon data corresponding to the hatched polygons in FIG. 24 are read.

In the print data outputting processing shown in FIG. 20, such a processing is repeated until the all polygons are processed. Finally, when it is determined that the all polygons have been processed (step S208: YES), the print data outputting processing is ended and the image printing processing shown in FIG. 15 is performed again.

As described above with reference to FIG. 15, when the procedure is returned to the image printing processing from the print data outputting processing, the game restarting processing for restarting the game (step S114 of FIG. 15) is performed and thus the stopped game is restarted. As a result, the game is restarted from the stopped portion.

On the other hand, the color printer 200 prints an image on a print sheet in accordance with the print data supplied from the game machine 100. Hereinafter, the processing of allowing the color printer 200 to receive the print data and to print an image will be described in brief. In the following description, it is described that the printing processing is performed by a CPU mounted on the color printer 200, but only an interlace processing or a processing of forming dots to be described later may be performed by the color printer 200 and other processes may be performed by the game machine 100.

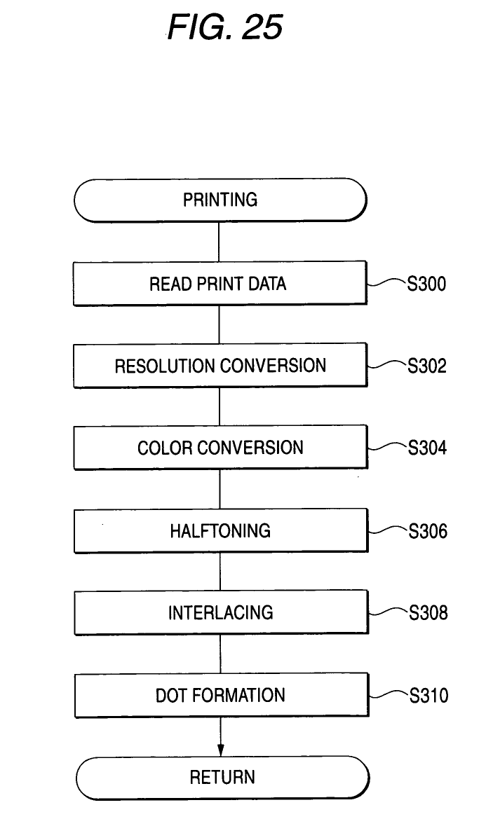

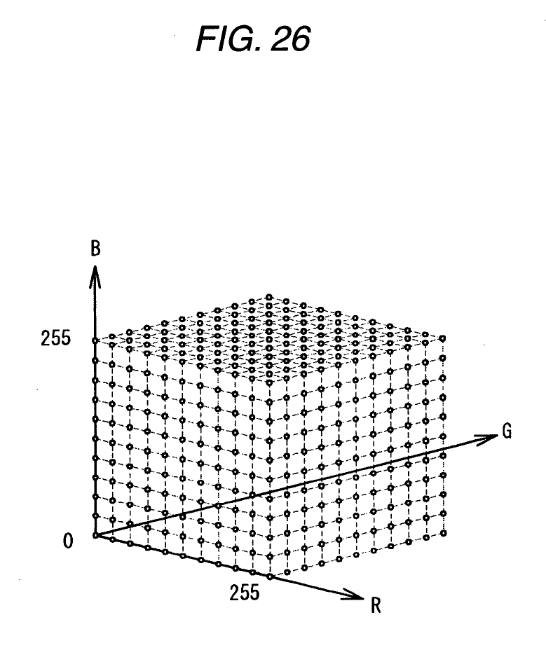

When the printing processing shown in FIG. 25 is started, the CPU mounted on the color printer 200 performs the processing of reading the print data output from the game machine 100 (step S300). Next, a resolution changing processing is started (step S302). The resolution changing processing is a processing of changing a resolution of the image data, which are developed in the frame buffer 114 and supplied as the print data, to a resolution (print resolution) for allowing the color printer 200 to actually print the image. When the print resolution is greater than the resolution of the image data, the resolution is increased by performing an interpolation operation to generate new image data of pixels. On the contrary, when the resolution of the image data is greater than the print resolution, the resolution is decreased by omitting the read image data at a constant ratio. In the resolution changing process, the resolution of the image data is changed to the print resolution by performing the operation to the print data supplied from the game machine 100.

When the above-described color converting processing is executed, the CPU installed in the color printer 200 starts a halftoning processing (step S306). The halftoning processing is the following processing. Image data provided by the color converting processing is gray scale data which can take values from a gray scale value 0 to a gray scale value 255 for respective pixels when a data length is set to 1 byte. In contrast thereto, the color printer 200 expresses an image by forming dots and therefore, only either of states of “forming dot” and “not forming dot” can be selected for respective pixels. Therefore, the color printer 200 expresses a middle gray scale by changing a density of dots formed in a predetermined region instead of changing the gray scale values of the respective pixels. The halftoning processing is a processing of determining whether dots are formed or not for respective pixels such that dots are produced by a pertinent density in accordance with the gray scale value of the image data.

As a method of producing dots by a pertinent density in accordance with the gray scale value, various methods of an error diffusing method, a dithering method and the like are applicable. The error diffusing method is a method of determining whether dots are formed or not with regard to respective pixels such that an error in expressing the gray scale produced at a pixel by determining whether dots are formed or not with respect to a certain pixel is diffused to surrounding pixels and an error diffused from surrounding is resolved. A rate of diffusing the produced error to surrounding respective pixels is set previously to an error diffusing matrix. Further, the dithering method is a method of determining whether dots are formed or not with regard to respective pixels by comparing a threshold set in a dithering matrix and a gray scale value of image data for respective pixels, determining to form dots for a pixel at which the gray scale of the image data is larger and conversely determining not to form dots with regard to a pixel in which the threshold is larger. In this embodiment, either of the methods can be used, however, at this occasion, the halftoning processing is executed by using the method referred to as the dithering method.

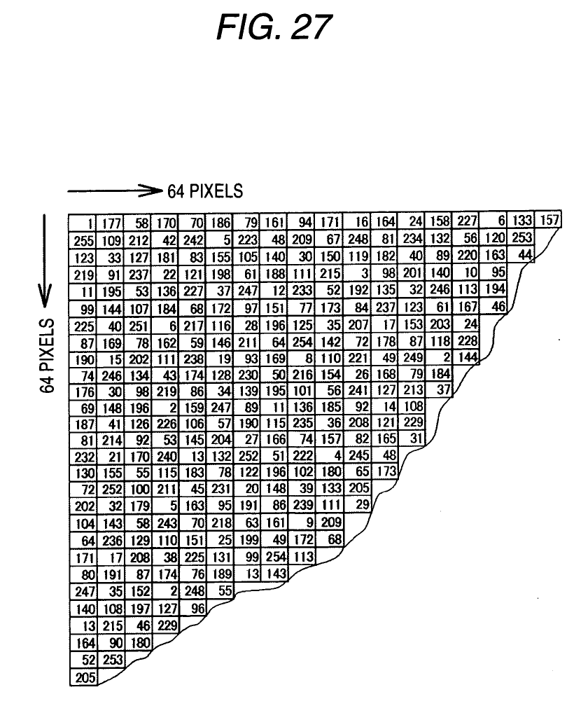

As shown in FIG. 27, the matrix is set with thresholds evenly selected from a range of gray scale values of 0 through 255 for respective vertical and horizontal 64 pixels, or a total of 4096 pieces of pixels. Here, the gray scale values of the thresholds are selected from the range of 0 through 255 in correspondence with the fact that the image data is constituted by 1 byte data and the gray scale values set for the pixels can take values of 0 through 255. Further, a size of the dithering matrix is not limited to an amount of vertical and horizontal 24 pixels as exemplified in FIG. 27 but can be set to various sizes including a size in which numbers of vertical and horizontal pixels differ from each other.

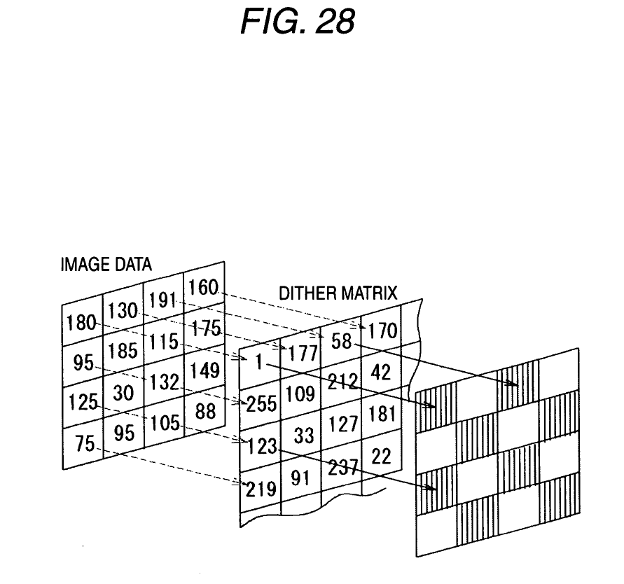

In determining whether dots are formed or not, first, a gray scale value of image data with regard to a pixel aimed as an object of determination (aimed pixel) and a threshold stored to a corresponding position in the dithering matrix are compared. Dashed arrows shown in FIG. 28 schematically expresses that the gray scale value of the aimed pixel and the threshold stored at the corresponding position in the dithering matrix are compared. Further, when the gray scale of the aimed pixel is larger than the threshold of the dithering matrix, it is determined that dots are formed for the pixel. Conversely, when the threshold of the dithering matrix is larger, it is determined that dots are not formed for the pixel.

In this example, the image data of a pixel disposed at a left upper corner of image data is provided with a gray scale value of 180 and a threshold stored at a position on the dithering matrix in correspondence with the pixel is 1. Therefore, with regard to the pixel at the left upper corner, the gray scale value 180 of the image data is larger than the threshold 1 of the dithering matrix and therefore, it is determined that dots are formed for the pixel. Solid arrows shown in FIG. 28 schematically expresses a behavior of determining that dots are formed for the pixel and writing a result of the determination to a memory. On the other hand, with regard to a right next pixel of the pixel, the gray scale value of the image data is 130, the threshold of the dithering matrix is 177, the threshold is larger and therefore, it is determined that dots are not formed for the pixel. According to the dithering method, dots are produced in reference to the dithering matrix in this way. In step S306 of the printing processing shown in FIG. 25, the processing of determining formation of a dot as described above is performed to the gray scale values of C, M, Y, and K colors changed through the color changing process.

When the halftoning processing is ended, the CPU of the color printer 200 starts the interlacing processing (step S308). The interlacing processing is a processing of rearranging the image data converted into the format corresponding to the formation of dots in consideration of the order in which the color printer 200 actually forms the dots on a print sheet.

When the interlacing processing is performed, an image is printed by forming the dots on the print sheet on the basis of the acquired data. That is, as described above in reference to FIG. 2, primary scanning and secondary scanning of the carriage 240 are executed by driving the carriage motor 230 and the sheet feeding motor 235 and ejecting ink drops by driving the printing head 241 in accordance with movements thereof, thereby, ink dots are formed. As a result, a printed image of a scene the same as that displayed on the screen of the monitor 150 is provided.

As described above, in the game machine 100 according to the present embodiment, when printing an image displayed on the monitor 150, the minute polygon data are generated by replacing the polygon data (displaying polygon data) of the coarse polygons used for displaying an image with the polygon data (printing polygon data) of the minute polygons used for printing an image. The image is printed by generating the print data on the basis of the minute polygon data. Accordingly, since an object is formed out of small polygons in the printed image and thus the surface is not angular, an image like a photograph obtained by taking a photograph of an existing object is obtained.

Of course, since the printing polygon data includes the minute polygons, the number of polygons is greater than that of the displaying polygon data. Accordingly, when the displaying polygon data are replaced with the printing polygon data, the number of polygons constituting a sheet of printed image increases. When the number of polygons increases, it is difficult to perform the imaging processing at a time to the all polygons data due to the restriction to the memory capacity of the game machine 100. Specifically, when the printing processing is performed on a large sheet having a sheet size of A3 or more, the minute polygons can be often used to maintain the image quality and thus the number of polygons increases as many. Accordingly, such a tendency becomes remarkable. However, in the game machine according to the present embodiment, the imaging processing can be performed to the polygon data read by the predetermined number of polygons and the image data developed in the frame buffer 114 can be supplied to the color printer 200 as the print data every time. As a result, even when the printing processing is performed on a large-sized sheet of paper, it is possible to print an image without the restriction to the memory capacity.

The game machine 100 according to the first embodiment described above can be modified in various forms. Now, the modified examples will be described in brief.

In the above-mentioned embodiment, it has been described that the minute polygon data are read by the predetermined number of polygons to perform the imaging processing and the resultant image data are output as the print data in the print data outputting processing. In this case, even when the memory capacity of the frame buffer 114 is not sufficient, it is possible to perform the imaging processing and to output the print data within the allowable range of the memory capacity. However, without fixing the number of polygons to be read to a predetermined number, the polygons may be read and subjected to the imaging processing until the amount of data developed in the frame buffer 114 reaches a predetermined amount.

The print data outputting processing according to the first modified example is different from the print data outputting processing according to the first embodiment described with reference to FIG. 20, in that the polygon data are read in a unit of polygon and are subjected to the imaging processing until the amount of data developed in the frame buffer 114 reaches an allowable value. The print data outputting processing according to the first modified example will be described focusing on the difference.

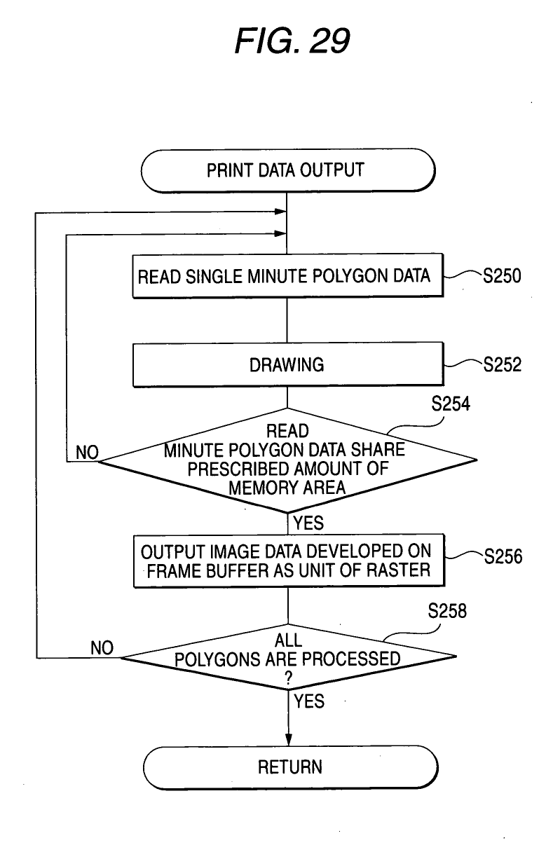

As shown in FIG. 29, when the print data outputting processing according to the first modified example is started, the processing of reading the minute polygon data from the main memory 110 is first performed (step S250). In the print data outputting processing according to the first embodiment described above, the polygon data have been read by the predetermined number of polygons, but in the first modified example, the polygon data are read by one polygon.

Next, the imaging processing is performed to the read polygon data (step S252). As a result, the image data corresponding to one polygon read are developed in the frame buffer 114.

When the polygon data are developed in this way, it is determined whether the data developed in the frame buffer 114 reaches a predetermined allowable value (step S254). The allowable value is set to a value (for example, a value corresponding to 90% of the memory capacity) giving a certain margin with respect to the memory capacity of the frame buffer 114. When it is determined that the developed image data does not reach the allowable value (step S254: NO), it is determined that new polygon data can be developed. Then, the polygon data corresponding to another polygon are read from the minute polygon data (step S250), the imaging processing is performed to the read polygon data to develop the image data (step S252), and then it is determined whether the developed data reaches the allowable value of the memory (step S254). When it is determined that the data developed in the frame buffer 114 reaches the allowable value (step S254: YES) by repeating the above-mentioned operation, the developed image data are read in a unit of raster and are output as the print data (step S256). Since such a processing is similar to the print data outputting processing according to the first embodiment described above with reference to FIGS. 20 and 22, the description thereof is omitted herein.

When the image data in a unit of raster are output as the print data, it is determined whether the processing is ended with respect to the all polygons of the minute polygon data having been subjected to the rendering processing (step S258). When it is determined that polygons not processed remain (step S258: NO), step S250 is performed again and new data corresponding to another polygon are read from the minute polygon data stored in the main memory 110. The above-mentioned series of processes are repeated. Finally, when it is determined that the processing is ended with respect to the all polygons (step S258: YES), the print data outputting processing according to the first modified example shown in FIG. 29 is ended and the procedure is returned to the image printing processing shown in FIG. 15.

In the print data outputting processing according to the first modified example described above, it is possible to efficiently use the memory capacity of the frame buffer memory 114 to output the print data, regardless of the size of the read polygons. Accordingly, it is possible to rapidly perform the print data outputting processing and to rapidly print an image.

In the print data outputting processing according to the first embodiment described above, when the image data are developed in the frame buffer 114, a raster which can be output is detected and is output as the print data. Then, in the next operation, a new raster is detected from the image data newly developed in the frame buffer 114 and is output as the print data. Accordingly, every time new image data are developed in the frame buffer 114, new print data are sequentially output without overlapping with each other. On the contrary, every time the image data are developed in the frame buffer 114 to output the print data, a part of the print data developed and output at the previous time may be output repeatedly.

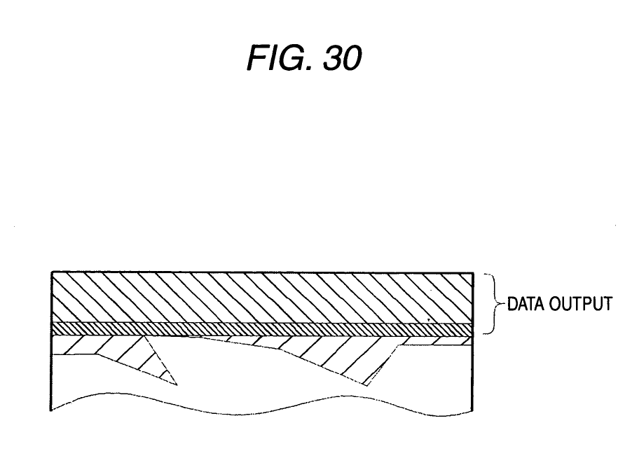

In FIG. 30, the hatched area in the figure indicates an area of which the image data are developed in the frame buffer 114. This figure shows various hatched areas having from coarse hatching to fine hatching, but all the areas are areas of which the image data are developed.

When the print data are output, the image data are read in a unit of raster from the areas and are output as the print data. In the finely hatched areas and the medium hatched areas in the figure, the image data can be read in a unit of raster and thus the image data of the areas are output as the print data.

Here, in the print data outputting processing according to the second modified example, the data of the second half portion (finely hatched area in FIG. 30) of the area of which the image data are output as the print data are not discarded and are stored, after the print data are output. Then, the data of next polygons are read and developed in the frame buffer 114 and the stored print data are output to the color printer 200 before the new print data are output. Thereafter, the new print data are output. As a result, the print data are output two times from the portion.

As for the joint portion of the image data read and developed every time, when the print data are repeatedly output to the color printer 200 and the print data are received with the divided state, it is possible to avoid the deterioration of the print quality in the joint portion.

In the image printing processing according to the first embodiment described hitherto, the printing polygon data including fine polygons are stored in advance, the minute polygon data are generated at the time of printing an image by replacing the displaying polygon data with the printing polygon data, and then a series of processes such as the rendering processing and the imaging processing are performed to the objects including the acquired minute polygon data, thereby printing an image. Alternatively, without preparing in advance the printing polygon data, the printing polygon data may be generated from the displaying polygon data and then such a series of processes such as the rendering processing may be performed to the generated printing polygon data. Hereinafter, such an image printing processing according to a second embodiment will be described.

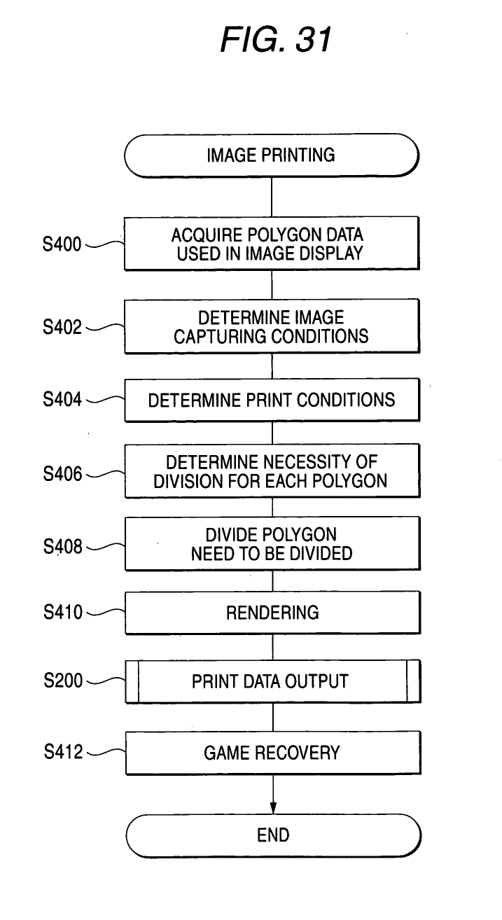

Such an image printing processing is different from the image printing processing according to the first embodiment described above, in that the printing polygon data including fine polygons are generated from the displaying polygon data, and other processes are substantially similar to the processes according to the first embodiment. Now, the image printing processing according to the second embodiment will be described focusing on the difference with reference to FIG. 31.

Similarly to the first embodiment, in the image printing processing according to the second embodiment, the CPU 101 of the game machine 100 generates an interruption and starts the image printing processing when detecting that the printing button of the controller 102 is pressed. The CPU acquires the polygon data (displaying polygon data) as a source of an image having been displayed on the monitor 150 at the time when the printing button of the controller 102 is pressed (step S400).

Next, the image capturing conditions and the printing conditions of the image are set (step S402 and step S404). The image capturing conditions are set such as a focal length, a focusing position, and an aperture value while checking the image (see FIG. 16) displayed on the monitor 150. The printing conditions are set such as a sheet size, a sheet kind, and a printing mode while checking the image (see FIG. 17) displayed on the monitor 150.

Subsequently, it is determined whether the polygons constituting each object displayed on the monitor 150 should be divided (step S406). The determination of division of the polygons is performed in accordance with the “sheet size” and the “printing mode” set in the printing condition setting process. For example, when the printing mode is set to “fast” and the sheet size is set to a “normal size photograph” or an “L-size photograph”, the division of polygons is not performed. When the printing mode is set to “fast” and a large-area paper print is not performed, the printing quality is not high and the printed image is small. Accordingly, even when the displaying polygon data are printed (including angular polygons), the polygons are not recognized. On the contrary, when the printing mode is set to “fine” or the large-area paper printing with an A4 or greater size of a sheet is performed, the polygons should be divided so as not to deteriorate the image quality due to the visible polygons.

Next, as for the polygons of which the division is determined, the processing of generating the printing polygon data from the displaying polygon data is performed (step S408) by dividing the polygons.

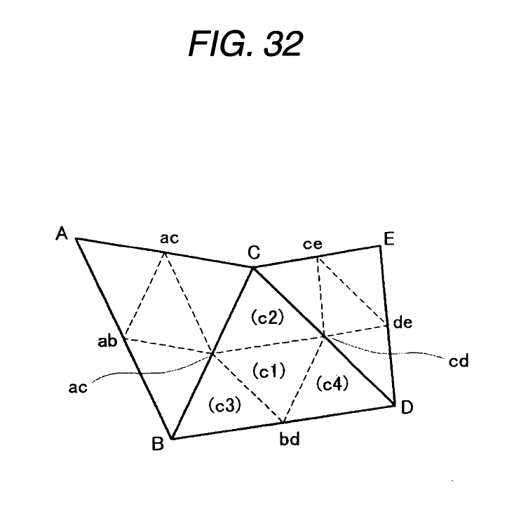

As shown in FIG. 32, three triangles indicated by solid lines in the figure illustrate the polygons before the division. When the polygons are divided, each polygon is divided into four small polygons by connecting middles points of sides constituting each polygon to each other. In the polygon of a triangle ABC shown in FIG. 32, the triangle ABC can be divided into four small triangles by connecting the middle point ab of side AB, the middle point bc of side BC, and the middle point ac of side AC to each other. Similarly, in the adjacent polygon of triangle BCD, the triangle BCD can be divided into four small triangles by connecting the middle point bc of side BC, the middle point cd of side CD, and the middle point bd of side BD to each other. In this way, the respective polygons constituting an object are divided into four small polygons by repeating such an operation to all the polygons. In step S408 of the image printing processing according to the second embodiment, the processing of dividing the polygons, of which the division is determined, into four small polygons is performed.

The texture numbers of the small polygons generated by dividing the polygons are determined on the basis of the texture number of the source polygon and the texture number of the adjacent polygon. For example, the determination of the texture numbers is described with reference to the polygon of the triangle BCD shown in FIG. 32. The small polygon c1 generated at the center is denoted by the texture number of the source polygon. On the other hand, the small polygon c2 interposed between the two neighboring polygons (triangle ABC and triangle CDE) is denoted by a texture number which is an intermediate texture number among the texture numbers of the two neighboring polygons and the texture number of the source polygon (triangle BCD). Similarly, the small polygon c3 generated through the division can be denoted by a texture number which is an intermediate texture number between the texture number of the neighboring polygon (triangle ABC) and the texture number of the source polygon (triangle BCD). In this way, when the polygons are divided into small polygons, vertexes of the small polygons generated through the division are detected, and the texture numbers of the small polygons are set, the polygon data of the polygons which are divided into the small polygons can be generated from the normal polygon data.

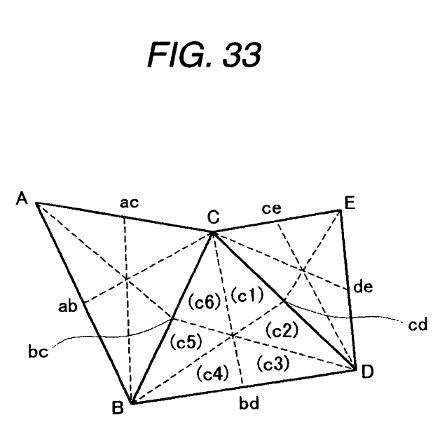

Each polygon may be divided into more small polygons or smaller polygons as shown in FIG. 33.

Similarly to the method shown in FIG. 32, the three triangles indicated by solid lines in the figure are polygons before the division. In this example, each polygon is divided into six small polygons by connecting the vertexes of the polygon and the middles points of sides opposed to the vertexes to each other. In the polygon of triangle ABC shown in FIG. 33, the triangle ABC is divided by connecting the vertex A to the middle point bc of the side BC opposed thereto, connecting the vertex B to the middle point ac of the side AC opposed thereto, and connecting the vertex C to the middle point ab of the side AB opposed thereto. Since the straight lines connecting the vertexes to the opposite sides, respectively, intersect each other at the center of gravity of the triangle, the triangle can be divided into six small polygons. The polygons may be divided by selecting a proper method depending upon the printing conditions such as a large size sheet and the like.

When the polygons are divided in this way, the displaying polygon data are replaced with the printing polygon data, thereby obtaining the minute polygon data. After the minute polygon data are generated in this way, an image is printed similarly to the image printing processing according to the first embodiment. The image printing processing will be described in brief.

First, the rendering processing is performed to the generated minute polygon data (step S410). As described above with reference to FIG. 11, the rendering processing is a processing of generating two-dimensional image data from the polygon data of the respective objects. The two-dimensional image data acquired through the rendering processing include two-dimensional coordinates obtained by projecting the vertexes of the polygons onto the projecting face and the texture numbers given to the projected polygons and the data having such a format are stored in the main memory 110.

By performing the print data outputting processing subsequently to the rendering process, the image data developed in the frame buffer 114 are read in a unit of raster and then are output as the print data to the color printer 200 (step S200). Such a processing is equal to the print data outputting processing according to the first embodiment and thus description thereof will be omitted herein.

When the image printing processing according to the second embodiment is returned from the print data outputting processing, the game restarting processing is performed (step S412). That is, since the image printing processing according to the second embodiment is started in the state that the game in progress is stopped, various data such as program counters are returned to the state before stopping the game so as to perform preparation for restarting the game, before ending the image printing process. When the game restarting processing is ended, the image printing processing according to the second embodiment shown in FIG. 31 is ended.

In the image printing processing according to the second embodiment, when the image displayed on the monitor 150 is printed, the polygons of the objects are divided into fine polygons depending upon the printing conditions and the minute polygon data are generated. The image is printed on the basis of the obtained minute polygon data, so it is possible to print the image with high quality in which the polygons are not visible. The precision in expression of the shapes of the objects is not enhanced by only dividing the polygons into fine polygons, but when the polygons are divided into fine polygons, it is possible to greatly alleviate an impression that the surfaces of the objects are angular, by giving proper texture to the polygons. Accordingly, when the image is printed out from the color printer 200, it is possible to obtain a printed image like a photograph obtained by taking a photograph of an existing object.

In the image printing processing according to the second embodiment, the printing polygon data are generated from the acquired polygon data by dividing the polygons. Accordingly, since the processing of positioning the acquired polygon data and the printing polygon data with each other by the use of the reference points as in the image printing processing according to the first embodiment is not necessary, it is possible to rapidly print an image even when the game machine 100 is relatively small in memory capacity and processing ability.

When the polygons are divided into fine polygons, the total number of polygons increases. Accordingly, it is difficult to develop the data of the all polygons in the frame buffer 114 collectively. However, in the print data outputting processing according to the second embodiment, the polygon data are read by the predetermined number of polygons (or by the predetermined number of polygons in which the developed image data are constant) and are subjected to the imaging process. Then, the image data developed in the frame buffer 114 are sequentially supplied as the print data to the color printer 200. As a result, even when the printing processing is performed on a large size sheet, it is possible to print an image without restriction to the memory capacity.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

For example, in the embodiments described above, it has been described that when an image displayed on the monitor 150 is printed, the image data for printing the image are generated based on the fine polygons and the generated image data are used only to generate the print data. However, the generated image data may be used to display the image on the monitor 150. For example, the generated image data based on the fine polygons may be displayed on the screen of the monitor 150 at the same time as starting the generation of the print data. The image data generated for the purpose of printing can display an image with quality higher than that of the image data generated for the purpose of displaying an image on the monitor 150 and are image data having subjected to various processes considering the image capturing conditions and the like. Therefore, by displaying the image data based on the fine polygons on the monitor 150 during generation of the print data, it is possible to check the effects on the monitor 150.

Alternatively, before starting the generation of printing data, the image data based on the minute polygons may be displayed on the screen of the monitor 150. In this case, since the setting items such as the image capturing conditions can be set while checking the effect of the setting by the use of the image data based on the minute polygons, it is possible to more property perform the setting.

What is claimed is:

1. An apparatus for outputting print data representative of an image to be printed by a printer, comprising:
a first data generator, operable to generate first image data representative of a first image of an object, based on first polygon data representative of a three-dimensional shape of the object with coordinates of apexes of each of first polygons constituting a surface of the object and having a first size;
a display, operable to display the first image;
a second data generator, operable to acquire, when a print instruction for the first image is detected, at least one of the first image data and the first polygon data to generate second image data representative of a second image of the object which includes second polygon data representative of the three-dimensional shape of the object with coordinates of apexes of each of second polygons constituting the surface of the object and having a second size smaller than the first size;
a third data generator, operable to generate plural sets of the print data each of which includes a prescribed amount of the second image data; and
data transmitter, operable to output each of the sets of the print data sequentially.

2. The apparatus as set forth in claim 1, further comprising a storage storing the first polygon data and the second polygon data,
wherein the second data generator generates the second image data by replacing at least a part of the first polygon data with the second polygon data.

3. The apparatus as set forth in claim 1, wherein the second data generator generates the second image data such that one of the first polygons is divided into a plurality of the second polygons.

4. The apparatus as set forth in claim 1, wherein:
the data transmitter sequentially outputs a first set of the print data representative of a first part of the second image and a second set of the print data representative of a second part of the second image which is adjacent to the first part of the second image; and
the data transmitter is operable to output the second set of the print data so as to partly include data in the first set of print data.

5. A method of outputting print data representative of an image to be printed by a printer, comprising:
generating first image data representative of a first image of an object, based on first polygon data representative of a three-dimensional shape of the object with coordinates of apexes of each of first polygons constituting a surface of the object and having a first size;
displaying the first image;
acquiring, when a print instruction for the first image is detected, at least one of the first image data and the first polygon data to generate second image data representative of a second image of the object which includes second polygon data representative of the three-dimensional shape of the object with coordinates of apexes of each of second polygons constituting the surface of the object and having a second size smaller than the first size;
generating plural sets of the print data each of which includes a prescribed amount of the second image data; and
outputting each of the sets of the print data sequentially.

6. A program product comprising a program adapted to cause a computer to execute a method for outputting print data representative of an image to be printed by a printer, comprising:
generating first image data representative of a first image of an object, based on first polygon data representative of a three-dimensional shape of the object with coordinates of apexes of each of first polygons constituting a surface of the object and having a first size;
displaying the first image;
acquiring, when a print instruction for the first image is detected, at least one of the first image data and the first polygon data to generate second image data representative of a second image of the object which includes second polygon data representative of the three-dimensional shape of the object with coordinates of apexes of each of second polygons constituting the surface of the object and having a second size smaller than the first size;
generating plural sets of the print data each of which includes a prescribed amount of the second image data; and
outputting each of the sets of the print data sequentially.
